(19) United States
(12) Patent Application Publication
(10) Pub. No.: US 2025/0272928 A1
(43) Pub. Date: Aug. 28, 2025

(54) AUGMENTED REALITY DEVICE FOR PROVIDING AUGMENTED REALITY SERVICE FOR CONTROLLING OBJECT IN REAL SPACE AND OPERATION METHOD THEREOF

(71) Applicant: SAMSUNG ELECTRONICS CO., LTD., Suwon-si (KR)

(72) Inventors: Hyeonggeon LEE, Suwon-si (KR); Yonggue HAN, Suwon-si (KR); Younghoon SONG, Suwon-si (KR)

(73) Assignee: SAMSUNG ELECTRONICS CO., LTD., Suwon-si (KR)

(21) Appl. No.: 19/073,988

(22) Filed: Mar. 7, 2025

Related U.S. Application Data
(63) Continuation of application No. PCT/KR2023/012100, filed on Aug. 16, 2023.

(30) Foreign Application Priority Data
Sep. 8, 2022 (KR) 10-2022-0114487
Oct. 19, 2022 (KR) 10-2022-0135234

(51) Int. Cl. G06T 19/00; G06T 5/77; G06T 7/11; G06T 7/50; G06T 7/73; G06T 7/90; G06T 15/04; G06T 17/00; G06T 19/20

(52) U.S. Cl. CPC G06T 19/006; G06T 5/77; G06T 7/11; G06T 7/50; G06T 7/73; G06T 7/90; G06T 15/04; G06T 17/00; G06T 19/20; G06T 2200/24; G06T 2207/20104; G06T 2219/2004; G06T 2219/2016

(57) ABSTRACT

Provided are an augmented reality device for providing an augmented reality service for controlling an object in a real world space, and an operating method for the same. The method may include recognizing a first plane comprising a wall and a second plane comprising a floor from a spatial image based on a photograph of the real world space; generating a three-dimensional (3D) model of the real world space by extending the wall and extending the floor along the respective planes and performing 3D in-painting on an area of the extended wall and the extended floor that is hidden by an obstructive object; segmenting an object selected by a user input from the spatial image based on two-dimensional (2D) segmentation; and segmenting the object on the spatial image from the real world space based on a 3D model or 3D position information of the object using 3D segmentation.

### CROSS-REFERENCES TO RELATED APPLICATIONS

This application is a continuation of International Application No. PCT/KR2023/012100, filed on Aug. 16, 2023, with the Korean Intellectual Property Office, which claims priority from Korean Patent Application No. 10-2022-0114487, filed on Sep. 8, 2022, with the Korean Intellectual Property Office, and Korean Patent Application No. 10-2022-0135234, filed on Oct. 19, 2022, with the Korean Intellectual Property Office, the disclosures of which are incorporated herein in their entireties.

### BACKGROUND

### Field

The present disclosure relates to an augmented reality device for providing an augmented reality service for controlling an object in a real world space, and an operation method performed by the augmented reality device. In detail, the present disclosure discloses an augmented reality device for providing an augmented reality service for controlling an object in a real world space as well as a virtual object by using image processing and augmented reality technology using a deep neural network, and an operating method of the augmented reality device.

### Related Art

Augmented reality is a technology that displays a virtual image together with a real world object by overlaying the virtual image on a physical environment space of the real world or the real world object. An augmented reality device (e.g., smart glasses) using augmented reality technology is efficiently used in everyday life, for example, for information search, direction guidance, and camera photography. In particular, smart glasses, as an example of an augmented reality device, are worn as a fashion item and mainly used for outdoor activities.

Because augmented reality technology is a technology that displays a virtual object in a real world space, it is essential to recognize the real world space in real time and utilize information of a recognized real world object. For example, when a user wants to replace furniture in a living room indoors, augmented reality services in the prior art use a method of awkwardly overlapping virtual furniture (virtual object) on real furniture (real world object). Augmented reality technology in the prior art uses a method of deleting an area of furniture to be replaced and arranging virtual furniture (virtual object). However, when multiple pieces of furniture are attached, it is difficult to selectively delete only a specific piece of furniture, and because inpainting is performed using a simple interpolation method, when the background is not completely flat but is bent between walls or between a wall and a floor, a virtual object is generated differently from a real world space. In particular, because an augmented reality device should continuously perform computationally intensive operations such as segmentation and inpainting using a deep neural network model while executing an augmented reality application to provide an augmented reality service, a processing time may be long, and heat generation and power consumption of the device may increase.

### SUMMARY

An aspect of the present disclosure provides an augmented reality device for providing an augmented reality service for controlling an object in a real world space. An augmented reality device according to an embodiment of the present disclosure may include a camera, at least one processor including processing circuitry, memory storing one or more instructions. The one or more instructions are configured to, when executed by the at least one processor individually or collectively, cause the augmented reality device to: obtain, through the camera, a spatial image based on a photograph of a real world space, identify a first plane comprising a wall and a second plane comprising a floor from the spatial image, generate a three-dimensional (3D) model of the real world space by extending the wall and extending the floor along their respective planes and performing 3D inpainting on an area of the extended wall and the extended floor that is hidden by an obstructive object, segment an object selected by a user input from the spatial image based on two-dimensional (2D) segmentation, and segment the object on the spatial image from the real world space based on a 3D model or 3D position information of the object using 3D segmentation.

An aspect of the present disclosure provides a method, performed by an augmented reality device, for providing an augmented reality service for controlling an object in a real world space. The method may include recognizing a first plane comprising a wall and a second plane comprising a floor from a spatial image based on a photograph of the real world space using a camera; generating a three-dimensional (3D) model of the real world space by extending the wall and extending the floor along the respective planes and performing 3D in-painting on an area of the extended wall and the extended floor that is hidden by an obstructive object; segmenting an object selected by a user input from the spatial image based on two-dimensional (2D) segmentation; and segmenting the object on the spatial image from the real world space based on a 3D model or 3D position information of the object using 3D segmentation.

An aspect of the present disclosure provides a non-transitory computer-readable storage medium storing one or more instructions. The instructions, when executed by one or more processors, cause the one or more processors to: identify a first plane comprising a wall and a second plane comprising a floor from the spatial image; generate a three-dimensional (3D) model of the real world space by extending the wall and extending the floor along their respective planes and performing 3D inpainting on an area of the extended wall and the extended floor that is hidden by an obstructive object; segment an object selected by a user input from the spatial image based on two-dimensional (2D) segmentation; and segment the object on the spatial image from the real world space based on a 3D model or 3D position information of the object using 3D segmentation.

### BRIEF DESCRIPTION OF THE DRAWINGS

The present disclosure may be readily understood from the following detailed description in conjunction with the accompanying drawings, and reference numerals denote structural elements.

FIG. 1 is a diagram illustrating a process in which an augmented reality device provides an augmented reality service for deleting, moving, or adding an object in a real world space, according to an embodiment of the present disclosure.

FIG. 2 is a diagram illustrating an augmented reality device for controlling an object in a real world space, according to an embodiment of the present disclosure.

FIG. 3 is a block diagram of an augmented reality device, according to an embodiment of the present disclosure.

FIG. 4 is a flowchart illustrating a process, performed by an augmented reality device, according to an embodiment of the present disclosure.

FIG. 5 is a flowchart illustrating method process, performed by an augmented reality device, for generating a three-dimensional (3D) model of a real world space, according to an embodiment of the present disclosure.

FIG. 6 is a diagram illustrating an augmented reality device obtaining a 3D model shape related to shapes of planes in a real world space, according to an embodiment of the present disclosure.

FIG. 7A is a diagram illustrating an augmented reality device distinguishing planes of a wall and a floor on a spatial image, according to an embodiment of the present disclosure.

FIG. 7B is a diagram illustrating an augmented reality device distinguishing planes of a wall and a window on a spatial image, according to an embodiment of the present disclosure.

FIG. 7C is a diagram illustrating an augmented reality device distinguishing planes of a wall and a floor with different patterns on a spatial image, according to an embodiment of the present disclosure.

FIG. 8 is a diagram illustrating an augmented reality device performing 3D inpainting, according to an embodiment of the present disclosure.

FIG. 9 is a diagram illustrating an augmented reality device performing two-dimensional (2D) segmentation from a spatial image, according to an embodiment of the present disclosure.

FIG. 10 is a flowchart illustrating a process of 3D segmentation by an augmented reality device based on whether a 3D model of an object is stored, according to an embodiment of the present disclosure.

FIG. 11 is a diagram illustrating an augmented reality device performing 3D segmentation using a pre-stored 3D model of an object, according to an embodiment of the present disclosure.

FIG. 12 is a diagram illustrating an augmented reality device for performing 3D segmentation when a 3D model of an object is not stored, according to an embodiment of the present disclosure.

FIG. 13 is a flowchart illustrating a process of orienting a 3D model in a real world space and rendering the 3D model, according to an embodiment of the present disclosure.

FIG. 14 is a flowchart illustrating a process of 3D segmentation and updating a segmentation result, according to an embodiment of the present disclosure.

### DETAILED DISCLOSURE

The terms used herein are those general terms currently widely used in the art in consideration of functions in the present disclosure but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the present disclosure.

The singular forms “a,” “an,” and “the” are intended to include the plural forms as well, unless the context clearly indicates otherwise. The terms used herein, including technical or scientific terms, may have the same meaning as commonly understood by one of ordinary skill in the art described in the present disclosure.

When a portion “includes” an element, another element may be further included, rather than excluding the existence of the other element, unless otherwise described. Also, the term “ . . . unit” or “ . . . module” refers to a unit that performs at least one function or operation, and may be implemented as hardware or software or as a combination of hardware and software.

The expression “configured (or set) to” used in the present disclosure may be replaced with, for example, “suitable for,” “having the capacity to,” “designed to,” “adapted to,” “made to,” or “capable of” according to a situation. The term “configured (or set) to” does not always mean only “specifically designed to” by hardware. Alternatively, in some situations, the expression “system configured to” may mean that the system is “capable of” operating together with another device or component. For example, “a processor configured (or set) to perform A, B, and C” may be a dedicated processor (e.g., an embedded processor) for performing a corresponding operation or a generic-purpose processor (e.g., a central processing unit (CPU) or an application processor) that may perform a corresponding operation by executing at least one software program stored in a memory.

Also, in the present disclosure, it will be understood that when elements are “connected” or “coupled” to each other, the elements may be directly connected or coupled to each other, but may alternatively be connected or coupled to each other with an intervening element between them, unless specified otherwise.

In the present disclosure, ‘augmented reality’ means showing a virtual image in a physical environment space of the real world or showing a real world object and a virtual image together.

In the present disclosure, an ‘augmented reality device’ may be a device capable of representing augmented reality, and may be any one of, for example, a mobile device, a smartphone, a laptop computer, a desktop computer, a tablet PC, an e-book terminal, a digital broadcasting terminal, a personal digital assistant (PDA), a portable multimedia player (PMP), a navigation device, an MP3 player, or a camcorder. However, the present disclosure is not limited thereto, and in an embodiment of the present disclosure, the augmented reality device may be implemented as augmented reality glasses being in the form of glasses that a user wears generally on his/her face, a head mounted display (HMD) apparatus that is mounted on a head, an augmented reality helmet, etc.

In the present disclosure, a ‘real word space’ refers to a space in the real world that a user sees through an augmented reality device. In an embodiment of the present disclosure, a real world space may refer to an indoor space. A real world object may be located in a real world space.

In the present disclosure, a ‘virtual object’ is an image generated through an optical engine and may include both a still image and a video. The virtual object may be shown together with a real scene and may be a virtual image representing information about a real world object in the real scene or information about an operation of an augmented reality device or a control menu. In an embodiment of the present disclosure, a ‘virtual object’ may include a user interface (UI) provided through an application or program executed by an augmented reality device. For example, a virtual object may be a UI including a bounding box that represents a recognition area such as a wall, a floor, or a window recognized from a spatial image.

A general augmented reality device includes an optical engine for generating a virtual object including light generated from a light source, and a waveguide formed of a transparent material to guide the virtual object generated by the optical engine to a user's eyes and also to view a real world scene. As described above, because the augmented reality device must be able to observe not only the virtual object but also the real world scene, an optical element for changing a path of light having straightness is basically required in order to guide light generated from the optical engine to the user's eyes through the waveguide. In this case, the path of light may be changed through reflection by a mirror or the like, or may be changed through diffraction by a diffraction element such as a diffractive optical element (DOE) or a holographic optical element (HOE), but the present disclosure is not limited thereto.

In the present disclosure, ‘inpainting’ refers to an image processing technology that restores a portion of an image which is hidden, lost, or distorted.

In the present disclosure, ‘segmentation’ refers to an image processing technology that classifies an object in an image into classes or categories, distinguishes the object from other objects or a background image in the image according to a classification result, and segments the object.

An embodiment of the present disclosure will now be described in detail with reference to the accompanying drawings for one of ordinary skill in the art to be able to perform the embodiment of the present disclosure without any difficulty. However, the present disclosure may be embodied in many different forms and is not limited to the embodiments of the present disclosure set forth herein.

Hereinafter, embodiments of the present disclosure will be described in detail with reference to the drawings.

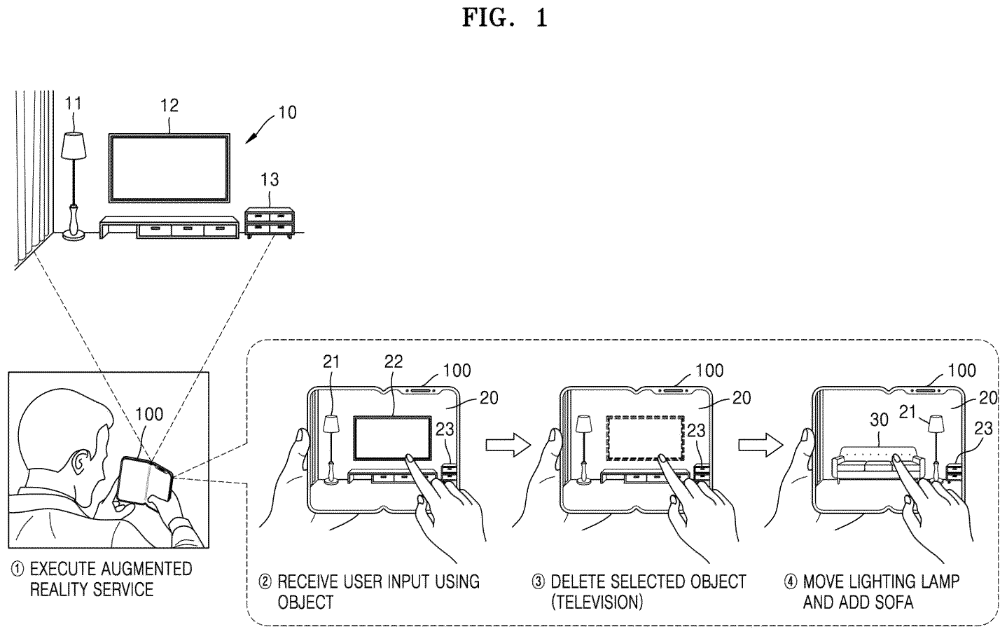

FIG. 1 is a conceptual diagram for describing an operation in which an augmented reality device 100 of the present disclosure provides an augmented reality service for deleting, moving, or adding objects (e.g., 11, 12, and 13) in a real world space 10.

The augmented reality device 100 is a device for providing an augmented reality service, and may be any one of, for example, a mobile device, a smartphone, a laptop computer, a desktop computer, a tablet PC, an e-book terminal, a digital broadcasting terminal, a personal digital assistant (PDA), a portable multimedia player (PMP), a navigation device, an MP3 player, or a camcorder. In an embodiment of FIG. 1, the augmented reality device 100 may be a smartphone. However, the present disclosure is not limited thereto, and in an embodiment of the present disclosure, the augmented reality device 100 may be implemented as augmented reality glasses being in the form of glasses that a user wears generally on his/her face, a head mounted display (HMD) apparatus that is mounted on a head, an augmented reality helmet, etc.

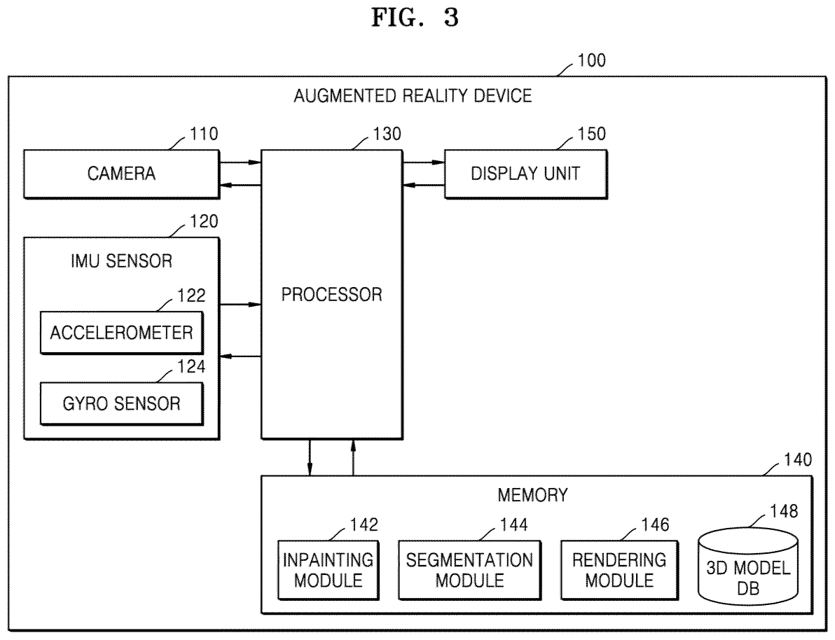

Referring to FIG. 1, the augmented reality device 100 may execute an augmented reality service (operation \textcircled{1}). In an embodiment of the present disclosure, the augmented reality device 100 may execute an augmented reality application to provide an augmented reality service to a user. In response to the augmented reality application being executed, the augmented reality device 100 may obtain a spatial image 20 by photographing the real world space 10 by using a camera 110 (see FIG. 3). The augmented reality device 100 may obtain the spatial image 20 including a plurality of image frames by photographing the real world space 10 in real time.

The augmented reality device 100 may display the spatial image 20 on a display unit and may receive a user input that selects a specific object on the spatial image 20 (operation \textcircled{2}). The spatial image 20 may include object images (e.g., 21, 22, and 23) of the objects (e.g., 11, 12, and 13) located in the real world space 10. For example, a first object image 21 may be an image of a lighting lamp that is a first object 11, a second object image 22 may be an image of a television that is a second object 12, and a third object image 23 may be an image of a table that is a third object 13. In an embodiment of the present disclosure, the augmented reality device 100 may include a touchscreen, and may receive a touch input of a user selecting any one object image from among the plurality of object images (e.g., 21, 22, and 23) included in the spatial image 20 displayed on the touchscreen. In the embodiment of FIG. 1, the augmented reality device 100 may receive a touch input of a user selecting the second object image 22 on the spatial image 20. The augmented reality device 100 may select the second object image 22 based on the touch input of the user. However, the present disclosure is not limited thereto. For example, in a case that the augmented reality device 100 is implemented as augmented reality glasses, an object may be selected based on a gaze point at which gaze directions of a user's two eyes converge. Also, in another example, in a case that the augmented reality device 100 is implemented as an HMD apparatus, an object may be selected based on a user input received through an external controller.

The augmented reality device 10 may delete the object selected by the user input (operation \textcircled{3}). In the embodiment of FIG. 1, the augmented reality device 100 may delete the second object image 22 selected by the user input from the spatial image 20. In an area where the second object image 22 is deleted, a wall and a floor hidden by the second object (television in the embodiment of FIG. 1) may be displayed. In an embodiment of the present disclosure, the augmented reality device 100 may recognize planes of the wall and the floor in the real world space 10 by using plane detection technology, and may generate a 3D model of the real world space 10 by extending the recognized planes of the wall and the floor and performing 3D inpainting on areas, hidden by the plurality of objects (e.g., 11, 12, and 13), of the extended plane areas of the wall and the floor. The augmented reality device 100 may segment the second object image 22 selected by the user input from the spatial image 20, by performing 3D segmentation. The augmented reality device 100 may display the area hidden by the second object image 22 segmented by 3D segmentation in the spatial image 20 by arranging the 3D model of the real world space 10 on the recognized planes of the wall and the floor in the real world space 10 and performing rendering using the 3D model. A specific 3D model generation method and a specific 3D segmentation method will be described in detail in the description of the drawings below.

The augmented reality device 100 may move and add an object image selected by a user input on the spatial image 20 (operation \textcircled{4}). In the embodiment of FIG. 1, the augmented reality device 100 may move a position of the first object image 21 related to the lighting lamp from a left side to a right side, and may add a new object image 30 of a sofa, which is an object that was not in the real world space 10. In an embodiment of the present disclosure, the augmented reality device 100 may move the first object image 21 or add the new object image 30, by using a pre-stored 3D model of an object or performing 3D segmentation using at least one of an edge, a feature point, or a 3D position coordinate value of a pixel of an object recognized from the spatial image 20.

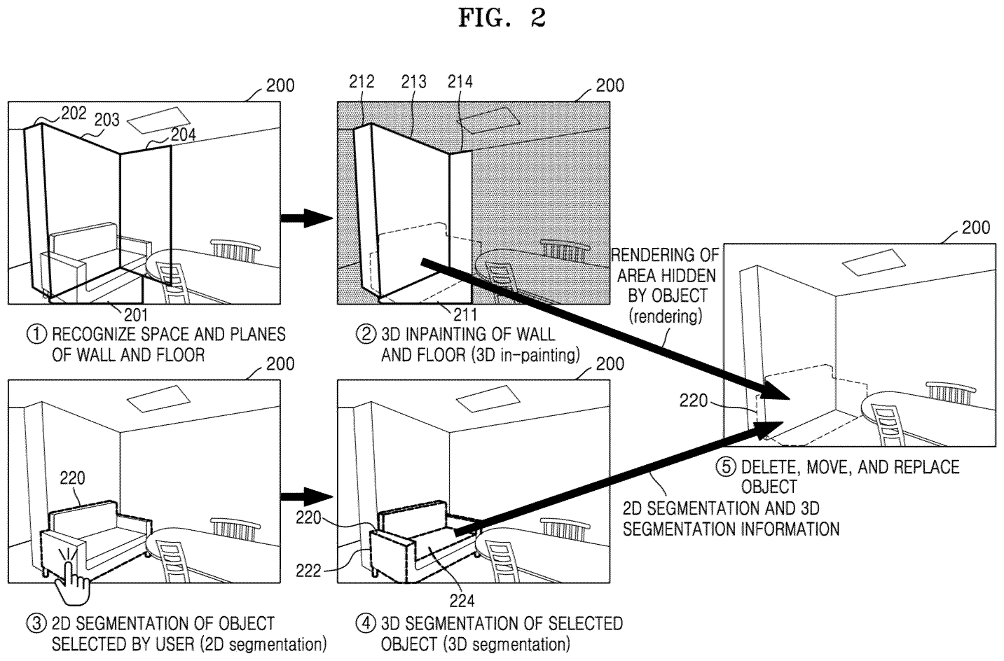

A specific method by which the augmented reality device 100 controls an object such as deleting, moving, or adding an object on the spatial image 20 of the real world space 10 will be described in detail with reference to FIG. 2.

FIG. 2 is a diagram illustrating an operation, performed by an augmented reality device, for controlling an object in a real world space, according to an embodiment of the present disclosure.

Referring to FIG. 2, the augmented reality device 100 (see FIG. 1) may recognize a space from a spatial image 200 of a real world space, and may recognize planes of walls 202, 203, and 204 and a floor 201 in the real world space (operation \textcircled{1}). The augmented reality device 100 may initiate an augmented reality service by executing an augmented reality application, and obtain the spatial image 200 by photographing the real world space by using the camera 110 (see FIG. 3). In an embodiment of the present disclosure, the augmented reality device 100 may recognize the planes of the walls 202, 203, and 204 and the floor 201 from the spatial image 200 by using plane detection technology provided by the augmented reality application.

The augmented reality device 100 may perform 3D inpainting on the walls and the floor (operation \textcircled{2}). In an embodiment of the present disclosure, the augmented reality device 100 may extract three arbitrary points from each of the recognized planes of the walls 202, 203, and 204 and the floor 201, and may derive a plane equation of each of the walls 202, 203, and 204 and the floor 201. The augmented reality device 100 may obtain a 3D model shape including virtual walls 212, 213, and 214 and a virtual floor 211 by extending the planes of the walls 202, 203, and 204 and the floor 201 based on the derived plane equation. The augmented reality device 100 may obtain depth value information of each wall, floor, and object in the real world space obtained from the camera 110, may obtain color information from the spatial image 200, and may distinguish areas of the virtual walls 212, 213, and 214, the virtual floor 211, and an object based on the depth value information and the color information. The augmented reality device 100 may perform inpainting on the areas hidden by the object for each of the virtual walls 212, 213, and 214 and the virtual floor 211 by using images of the walls 202, 203, and 204 of the real world space, except for, in the 3D model shape, a portion, hidden by an object, of the virtual walls 212, 213, and 214 and the virtual floor 211.

In the present disclosure, ‘inpainting’ refers to an image processing technology that restores a portion of an image that is hidden, lost, or distorted. In the present disclosure, ‘3D inpainting’ may refer to an image processing technology that restores an area of a 3D image hidden by a 3D object. The augmented reality device 100 may generate a 3D model including the virtual walls 212, 213, and 214 and the virtual floor 211 by performing inpainting. In an embodiment of the present disclosure, the augmented reality device 100 may store the generated 3D model in a storage space (e.g., a 3D model database 148 (see FIG. 3) in a memory 140 (see FIG. 3).

The augmented reality device 100 may perform 2D segmentation on an object selected by a user input (operation \textcircled{3}). Referring to an embodiment of FIG. 2, the augmented reality device 100 may receive a user input that selects an object to be controlled on the spatial image 200 displayed through the augmented reality application that is being executed. In an embodiment of the present disclosure, the augmented reality device 100 may display the spatial image 200 through a touchscreen, and may receive a user input that selects any one object 220 from among a plurality of objects included in the spatial image 200. The augmented reality device 100 may select the object 220 based on the user input, and may perform 2D segmentation on the object 220 based on 2D image information of the selected object 220 (e.g., 2D position coordinate information), and plane information of the walls 202, 203, and 204 and the floor 201, depth value information, and object distinction information obtained in operation \textcircled{1} and operation \textcircled{2}. In an embodiment of the present disclosure, the augmented reality device 100 may segment the object 220 selected by the user input by using a deep neural network model that is pre-trained to classify a plurality of objects into labels, classes, or categories. In the present disclosure, ‘segmentation’ refers to an image processing technology that classifies an object in an image, distinguishes the object from other objects or a background image in the image according to a classification result, and segments the object.

The augmented reality device 100 may perform 3D segmentation on the selected object 220 (operation \textcircled{4}). The augmented reality device 100 may perform 3D segmentation which is to segment the object 220 from the spatial image 200 by using information obtained through 2D segmentation. In an embodiment of the present disclosure, the 3D segmentation may be performed differently according to whether a 3D model of the object 220 is stored. For example, in a case that the 3D model of the object 220 is pre-stored in the storage space in the memory 140 (see FIG. 3), the augmented reality device may arrange the 3D model of the object 220 to overlap a 2D segmentation outlier on the spatial image 200 by adjusting a direction of the 3D model stored in the memory 140, and may obtain 3D position coordinate value information of the object 220 from the arranged 3D model. The augmented reality device 100 may perform 3D segmentation which is to segment the object 220 from the spatial image 200 based on the obtained 3D position coordinate value.

For example, in a case that the 3D model of the object 220 is not stored in the memory 140 (see FIG. 3), the augmented reality device 100 may perform 3D vertex modeling based on at least one of an edge 222, a feature point 224, and 3D position coordinate values of pixels of the object 220 recognized from the spatial image 200, and may perform 3D segmentation which is to segment the object 220 from the spatial image 200 through the 3D vertex modeling.

The augmented reality device 100 may perform at least one of deleting, moving, and replacing the object 220 (operation \textcircled{5}). The augmented reality device 100 may render an area hidden by the object 220 by using the 3D model. Through the rendering, the augmented reality device 100 may display an area segmented through the 3D segmentation of the object 220. The augmented reality device 100 may perform a deletion operation of deleting the object 220 from the spatial image 200, a replacement operation of replacing the object 220 with a virtual image of another object, or a movement operation of arranging the object 220 in another area, by using 2D segmentation information and 3D segmentation information of the object 220. Accordingly, the augmented reality device 100 may control the object 220 in the real world space in augmented reality.

Augmented reality services in the prior art use a method of awkwardly overlapping virtual objects on objects (e.g., 11, 12, and 13 of FIG. 1) in a real world space. For example, augmented reality technology in the prior art uses a method of deleting an area of furniture to be replaced and arranging virtual furniture (virtual object). However, when multiple pieces of furniture are attached, it is difficult to selectively delete only a specific piece of furniture, and because inpainting is performed using a simple interpolation method, when the background is not completely flat but is bent between walls or between a wall and a floor, a virtual object is generated differently from a real world space. In particular, a plurality of image frames of a real world space are obtained in real time while executing an augmented reality application to provide an augmented reality service. When an object is recognized and segmented by using a deep neural network model for each of the plurality of image frames obtained in real time, the amount of computation increases, and a processing time is long. When the amount of computation increases, real-time object recognition and segmentation are not performed normally and are delayed, thereby reducing the satisfaction of the augmented reality service and user convenience. Also, when object recognition and segmentation are performed for each image frame, heat generation and power consumption of a device increase. Due to characteristics of augmented reality devices designed to have a small form factor for portability, heat generation and power consumption may greatly affect a usage time of the device.

An objective of the present disclosure is to provide the augmented reality device 100 for providing an augmented reality service for freely controlling not only a virtual object in a real world space but also a real world object, and an operating method of the augmented reality device 100. According to an embodiment of the present disclosure, there is provided the augmented reality device 100 that recognizes planes of a wall and a floor from the spatial image (see 20 of FIG. 1 or 200 of FIG. 2), generates a 3D model of a real world space by extending the recognized planes and performing 3D inpainting, segments an object through 2D and 3D segmentations, and renders an area, hidden by an object, from among areas of the wall and the floor by using the 3D model.

When a plurality of image frames of a real world space are obtained in real time, because the augmented reality device 100 according to the embodiments of FIGS. 1 and 2 renders a wall and a floor by using a 3D model only in a case that there is a control by a user input such as deletion, movement, or replacement of an object, the amount of computation may be reduced compared to augmented reality technology in the prior art in which separate object recognition and segmentation are performed for each of the plurality of image frames. Accordingly, the augmented reality device 100 of the present disclosure provides technical effects of reducing computing power and suppressing heat generation of the device. Also, because the augmented reality device 100 according to an embodiment of the present disclosure stores a 3D model in a storage space (e.g., the 3D model database 148 (see FIG. 3)) in the memory 140 (see FIG. 3) and performs rendering by loading the 3D model only in a case that there is a control by a user input such as deletion, movement, or replacement of an object, a processing time may be reduced and a real-time augmented reality service may be provided.

FIG. 3 is a block diagram illustrating elements of the augmented reality device 100, according to an embodiment of the present disclosure.

Referring to FIG. 3, the augmented reality device 100 may include the camera 110, an inertial measurement unit (IMU) sensor 120, a processor 130, the memory 140, and a display unit 150. The camera 110, the IMU sensor 120, the processor 130, the memory 140, and the display unit 150 may be electrically and/or physically connected to each other. Although only essential elements for describing an operation of the augmented reality device 100 are illustrated in FIG. 3, elements included in the augmented reality device 100 are not limited to those illustrated in FIG. 3. In an embodiment of the present disclosure, the augmented reality device 100 may further include a communication interface for performing data communication with an external device or a server. In an embodiment of the present disclosure, the augmented reality device 100 may be implemented as a portable device, and in this case, the augmented reality device 100 may further include a battery that supplies power to the camera 110, the IMU sensor 120, the processor 130, and the display unit 150

The camera 110 is configured to obtain a spatial image of a real world space by photographing the real world space. In an embodiment of the present disclosure, the camera 110 may include a lens module, an image sensor, and an image processing module. The camera 110 may obtain a still image or a video of the real world space by using the image sensor (e.g., a CMOS or a CCD). The video may include a plurality of image frames obtained in real time by photographing the real world space through the camera 110. The image processing module may transmit a still image including a single image frame or video data including a plurality of image frames obtained through the image sensor to the processor 130. In an embodiment of the present disclosure, the image processing module may process the obtained still image or video, may extract required information, and may transmit the extracted information to the processor 130.

The inertial measurement unit (IMU) sensor 120 is a sensor configured to measure a movement speed, a direction, an angle, and a gravitational acceleration of the augmented reality device 100. The IMU sensor 120 may include an accelerometer 122 and a gyro sensor 124. Although not shown in FIG. 3, the IMU sensor 120 may further include a magnetometer.

The accelerometer 122 is a sensor configured to measure acceleration according to a change in movement when a dynamic force such as acceleration, vibration, or impact is generated in the augmented reality device 100. In an embodiment of the present disclosure, the accelerometer 122 may be configured as a three-axis accelerometer that measures acceleration in a row direction, a horizontal direction, and a height direction.

The gyro sensor (gyroscope sensor) 124 is a sensor configured to measure an angular velocity, which is a rotational change amount of the augmented reality device 100. In an embodiment of the present disclosure, the gyro sensor 124 may include a three-axis gyro sensor that measures roll, pitch, and yaw angular velocities.

In an embodiment of the present disclosure, the IMU sensor 120 may measure acceleration and angular velocity by using the accelerometer 122 and the gyro sensor 124, and may detect a direction of gravity based on the measured acceleration and angular velocity. The detected ‘direction of gravity’ may be the same as a direction of a normal vector of a floor surface of a real world space. The IMU sensor 120 may provide information about the direction of gravity to the processor 130.

The processor 130 may execute one or more instructions of a program stored in the memory 140. The processor 130 may include a hardware component for performing arithmetic, logic, and input/output operations and image processing. The processor 130 may include at least one of, for example, but not limited to, a central processing unit (CPU), a microprocessor, a graphics processing unit (GPU), an application-specific integrated circuit (ASIC), a digital signal processor (DSP), a digital signal processing device (DSPD), a programmable logic device (PLD), and a field-programmable gate array (FPGA).

In an embodiment of the present disclosure, the processor 130 may include an artificial intelligence (AI) processor that performs AI learning. The AI processor may be manufactured as a dedicated hardware chip for AI, or may be manufactured as a part of an existing general-purpose processor (e.g., a CPU or an application processor) or a dedicated graphics processor (e.g., a GPU) and mounted on the augmented reality device 100.

The processor 130 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing variety of the recited/disclosed functions, e.g., in a distributed manner. At least one processor may execute program instructions to achieve or perform various functions.

Although the processor 130 is single element in FIG. 3, the present disclosure is not limited thereto. In an embodiment of the present disclosure, the processor 130 may include a plurality of elements.

For example, the memory 140 may include at least one type of storage medium of, example, a flash memory type, a hard disk type, a multimedia card micro type, a card-type memory (e.g., an SD or XD memory), a random-access memory (RAM), a static random-access memory (SRAM), a read-only memory (ROM), an electrically erasable programmable read-only memory (EEPROM), a programmable read-only memory (PROM), or an optical disk.

The memory 140 may store instructions related to operations in which the augmented reality device 100 provides an augmented reality service for controlling an object in a real world space by performing 3D inpainting and 3D segmentation. In an embodiment of the present disclosure, at least one of instructions, an algorithm, a data structure, program code, or an application program readable by the processor 130 may be stored in the memory 140. The instructions, the algorithm, the data structure, and the program code stored in the memory 140 may be implemented in a programming or scripting language such as C, C++, Java, or assembler.

Instructions, an algorithm, a data structure, or program code related to an inpainting module 142, a segmentation module 144, and a rendering module 146 may be stored in the memory 140. A “module” included in the memory 140 refers to a unit that processes a function or an operation performed by the processor 130, and may be implemented as software such as instructions, an algorithm, a data structure, or program code. In an embodiment of the present disclosure, the 3D model database 148, which is a storage space, may be included in the memory 140.

In the following embodiments, the processor 130 may be implemented by executing the instructions or program code stored in the memory 140.

The processor 130 may execute an augmented reality application, and as the augmented reality application is executed, the processor 130 may obtain a spatial image of a real world space from the camera 110. In an embodiment of the present disclosure, the processor 130 may obtain the spatial image including a plurality of image frames obtained in real time by the camera 110.

The processor 130 may recognize planes including a wall and a floor from the spatial image. In an embodiment of the present disclosure, the processor 130 may detect a horizontal plane and a vertical plane from the spatial image by using plane detection technology, and may recognize the wall and the floor in the real world space from the detected horizontal plane and vertical plane. However, the present disclosure is not limited thereto, and the processor 130 may recognize a plane including a window or a door as well as the wall and the floor from the spatial image. In an embodiment of the present disclosure, the processor 130 may determine whether the recognized plurality of planes are the same plane through position information, and may integrate the plurality of planes into one plane in a case that the plurality of planes are the same plane.

The inpainting module 142 includes instructions or program code related to a function and/or an operation of extending the wall and the floor along the recognized planes from the spatial image and performing 3D inpainting on an area, hidden by an object, of the extended wall and floor by using the spatial image. The processor 130 may execute the instructions or the program code of the inpainting module 142 to obtain a 3D model shape of the wall and the floor and perform inpainting on the 3D model shape by using information of the spatial image. In an embodiment of the present disclosure, the processor 130 may derive a plane equation from each of planes including the recognized wall and floor. The processor 130 may extract three points with a high confidence index from each of the recognized wall and floor and may define a plane based on the extracted three points. In an embodiment of the present disclosure, the processor 130 may recognize a direction of a normal vector of a floor surface based on information about a direction of gravity obtained from the IMU sensor 120, and may determine whether 90° is formed between the normal vector of the floor surface and a normal vector of a wall surface. When an angle between the normal vector of the floor surface and the normal vector of the wall surface differs by ±3° to ±5° from 90°, the processor 130 may perform plane re-recognition.

The processor 130 may obtain a 3D model shape of a virtual wall and a virtual floor by extending the wall and the floor based on the derived plane equation. In an embodiment of the present disclosure, the processor 130 may extract an intersection line where the extended wall and floor meet each other, and may distinguish planes of the wall and the floor based on the extracted intersection line. The processor 130 may obtain vertex coordinates of each of the distinguished planes, and may generate the 3D model shape including the virtual wall and the virtual floor based on the obtained vertex coordinates.

The processor 130 may identify an object located on the wall and the floor in the real world space from the spatial image. The processor 130 may obtain depth information and color information of the real world space from the spatial image, and may identify an object based on at least one of the obtained depth information and color information. In an embodiment of the present disclosure, the processor 130 may identify 3D position coordinate values of the wall and the floor through plane detection technology, and when a depth value other than a depth value including z-axis coordinate information of the identified 3D position coordinate values of the wall and the floor is obtained, the processor 130 may determine that there is an object. In a case that it is difficult to identify an object by using depth information, the processor 130 may identify an object by using color information obtained from the spatial image. The processor 130 may distinguish the identified object from the recognized wall and floor.

The processor 130 may inpaint an area hidden by the identified object in the 3D model shape including the virtual wall and the virtual floor. In an embodiment of the present disclosure, the processor 130 may inpaint an area, hidden by the object, of the wall and the floor by using information of the spatial image. In the present disclosure, ‘inpainting’ refers to an image processing technology that restores a portion of an image that is hidden, lost, or distorted. In an embodiment of the present disclosure, the processor 130 may inpaint an area hidden by the object by using images of wall and floor portions of the spatial image respectively corresponding to the wall and the floor. However, the present disclosure is not limited thereto, and in an embodiment of the present disclosure, the processor 130 may inpaint an area hidden by the object on the wall and the floor by combining the images of the wall and floor portions of the spatial image with a virtual image.

The processor 130 may generate a 3D model of the real world space by applying a texture of an inpainted image to the 3D model shape including the virtual wall and the virtual floor. In an embodiment of the present disclosure, the processor 130 may generate a 3D model of the real world space through image processing of applying a texture of an inpainted image to the 3D model shape.

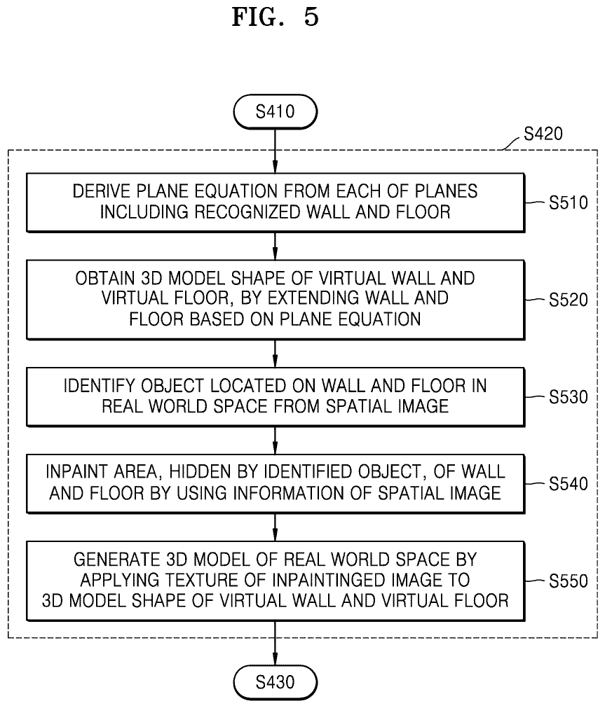

In an embodiment of the present disclosure, the processor 130 may store the generated 3D model in the 3D model database 148 in the memory 140. A specific embodiment in which the processor 130 generates a 3D model of a real world space by performing inpainting will be described in detail with reference to FIGS. 5 to 8.

The augmented reality device 100 may further include an input interface for receiving a user input that selects a specific object on the spatial image. For example, the input interface may include a keyboard, a mouse, a touchscreen, or a voice input device (e.g., a microphone), and may include any of other input devices obvious to one of ordinary skill in the art. In an embodiment of the present disclosure, the display unit 150 may include a touchscreen including a touch panel, and the touchscreen may receive a touch input of a user that selects a specific object on the spatial image displayed on the display unit 150. The processor 130 may select an object based on the touch input received from the user. However, the present disclosure is not limited thereto, and in an embodiment of the present disclosure, in a case that the augmented reality device 100 is implemented as augmented reality glasses, the input interface may include a gaze tracking sensor that detects a gaze point at which gaze directions of the user's two eyes converge. In this case, the processor 130 may select an object where a gaze point detected by the gaze tracking sensor is located. In an embodiment of the present disclosure, when the augmented reality device 100 is implemented as an HMD apparatus, the processor 130 may select an object based on a user input received through an external controller.

The segmentation module 144 includes instructions or program code related to a function and/or an operation of classifying an object in the spatial image into classes or categories, distinguishing the object with other objects or a background image in the image according to a classification result, and segmenting the object from the spatial image. The processor 130 may execute the instructions or the program code of the segmentation module 144 to recognize an object selected by a user input and perform segmentation which is to segment the recognized object from the spatial image. In an embodiment of the present disclosure, the processor 130 may obtain image information, 2D position coordinate information, and depth value information of the object selected by the user input from the spatial image. The processor 130 may perform 2D segmentation on the object based on at least one of the image information, 2D position coordinate information, and depth information of the object, plane information obtained through plane detection, and object distinction information. In the present disclosure, ‘2D segmentation’ refers to an image processing technology that distinguishes an object with other objects or a background image in an image and segments a 2D outlier of the object from the image. In an embodiment of the present disclosure, 2D segmentation may include not only segmenting a 2D outline of an object but also classifying the object into classes or categories and distinguishing the object from other objects or a background image in an image according to a classification result.

In an embodiment of the present disclosure, the processor 130 may segment the object selected by the user input by using a deep neural network pre-trained to classify a plurality of objects into labels, classes, or categories. The deep neural network model may be an AI model including model parameters pre-trained by applying tens of thousands to hundreds of millions of images as input data and applying a label value of an object included in an image as a ground truth. The deep neural network model may include at least one of, for example, a convolutional neural network (CNN), a recurrent neural network (RNN), a restricted Boltzmann machine (RBM), a deep belief network (DBN), a bidirectional recurrent deep neural network (BRDNN), and a deep Q-network. The deep neural network model may be stored in the memory 140, but the present disclosure is not limited thereto. In an embodiment of the present disclosure, the deep neural network model may be stored in an external server, and the augmented reality device 100 may transmit image data of the spatial image to the server and may receive information about a classification result of the object, which is an inference result, from the deep neural network model of the server.

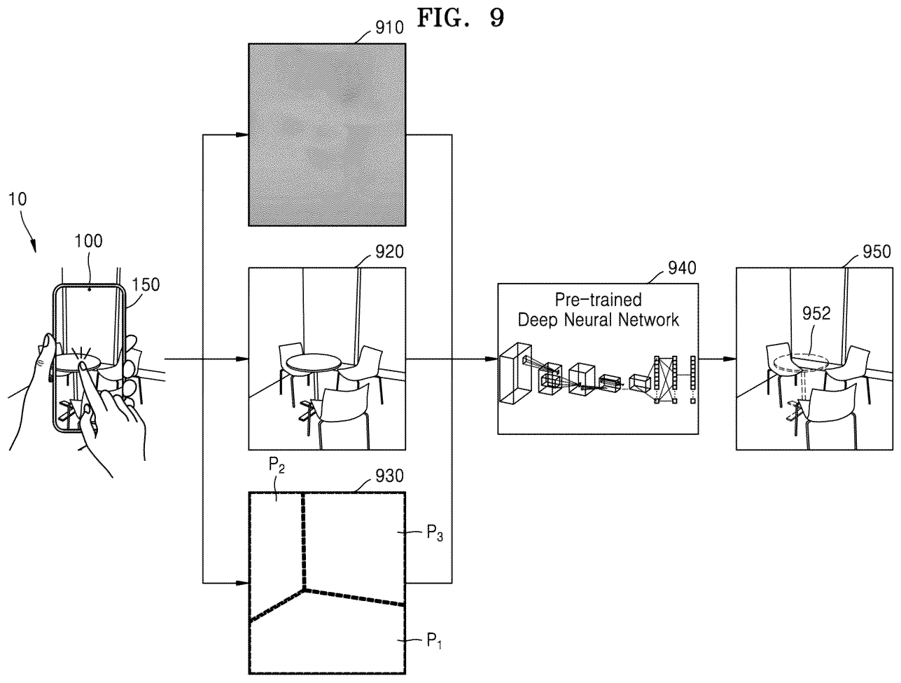

A specific embodiment in which the processor 130 segments an object selected by a user input through 2D segmentation using a pre-trained deep neural network model will be described in detail with reference to FIG. 9.

The processor 130 may execute the instructions or the program code of the segmentation module 144 to perform 3D segmentation which is to segment the object on the spatial image from the real world space. The 3D segmentation may be performed differently according to whether a 3D model of the object selected by the user input is stored in the 3D model database 148. In an embodiment of the present disclosure, when a 3D model of the object selected by the user input is pre-stored in the 3D model database 148, the processor 130 may load and obtain the pre-stored 3D model from the 3D model database 148, and may arrange the 3D model on the spatial image to overlap a 2D segmentation outlier on the spatial image by rotating a direction of the obtained 3D model in a z-axis direction. The processor 130 may obtain a 3D position coordinate value of the object from the arranged 3D model. The processor 130 may perform 3D segmentation which is to segment the object from the spatial image based on the obtained 3D position coordinate value.

In an embodiment of the present disclosure, when a 3D model of the object selected by the user input is not stored in the 3D model database 148, the processor 130 may obtain an edge, a feature point, and 3D position coordinate values of pixels of the object from the spatial image, and may perform 3D vertex modeling based on at least one of the obtained edge, feature point, and 3D position coordinate values of the pixels of the object. The processor 130 may perform the 3D segmentation which is to segment the object from the spatial image through 3D vertex modeling.

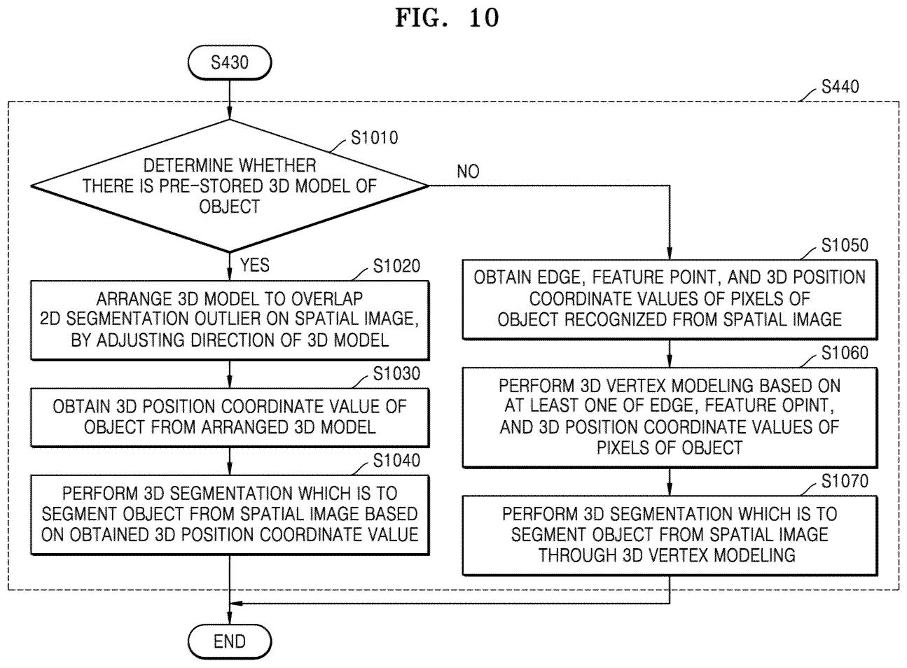

A specific embodiment in which the processor 130 performs 3D segmentation differently according to whether a 3D model of an object selected by a user input is stored will be described in detail with reference to FIGS. 10 to 12.

The rendering module 146 includes instructions or program code related to a function and/or an operation of rendering an area where the object is segmented through the 3D segmentation by using the 3D model. The processor 130 may execute the instructions or the program code of the rendering module 146 to arrange a 3D model of the wall and the floor at a position of the wall and the floor in the actual real world space, and when the object selected by the user input is segmented, to render an area deleted by the 3D segmentation. In an embodiment of the present disclosure, the processor 130 may perform rendering after an original image of the area where the 3D segmentation is performed is deleted. However, the present disclosure is not limited thereto, and in an embodiment of the present disclosure, the processor 130 may simply render a 3D model of the wall and the floor and may arrange the 3D model on an object of the real world space, without needing to delete the area where the 3D segmentation is performed. In this case, the processor 130 may set a depth testing value so that a real world object is rendered on the 3D model by adjusting a depth value between the 3D model and the object.

The 3D model database 148 is a storage space in the memory 140 in which 3D models of shapes of walls and floors of a real world space generated by the processor 130 are stored. In an embodiment of the present disclosure, the 3D model database 148 may store a 3D model of an object. The 3D model of the object stored in the 3D model database 148 may be, for example, a 3D model of an object in an indoor space such as furniture such as a sofa, a dining table, a table, or a chair, a TV, or a lighting lamp.

The 3D model database 148 may include a non-volatile memory. A non-volatile memory refers to a storage medium that stores and maintains information even when power is not supplied and may use the stored information again when power is supplied. The non-volatile memory may include at least one of, for example, a flash memory, a hard disk, a solid state drive (SSD), a multimedia card micro type, a card-type memory (e.g., SD or XD memory), a read-only memory (ROM), a magnetic memory, a magnetic disk, and an optical disk.

Although the 3D model database 148 is included in the memory 140 in FIG. 3, the present disclosure is not limited thereto. In an embodiment of the present disclosure, the 3D model database 148 may be configured as a database separate from the memory 140. In an embodiment of the present disclosure, the 3D model database 148 may be an element of an external third device or an external server, not the augmented reality device 100, and may be connected to the augmented reality device 100 through a wired/wireless communication network.

The display unit 150 is configured to display the spatial image captured through the camera 110 and the 3D model of the real world space. The display unit 150 may include at least one of, for example, a liquid crystal display, a thin-film transistor-liquid crystal display, an organic light-emitting diode, a flexible display, a 3D display, and an electrophoretic display. In an embodiment of the present disclosure, in a case that the augmented reality device 100 is configured as augmented reality glasses, the display unit 150 may further include an optical engine that projects a virtual image. The optical engine may include a projector configured to generate light of a virtual image and including an image panel, an illumination optical system, and a projection optical system. The optical engine may be located, for example, on a frame or glasses legs of the augmented reality glasses.

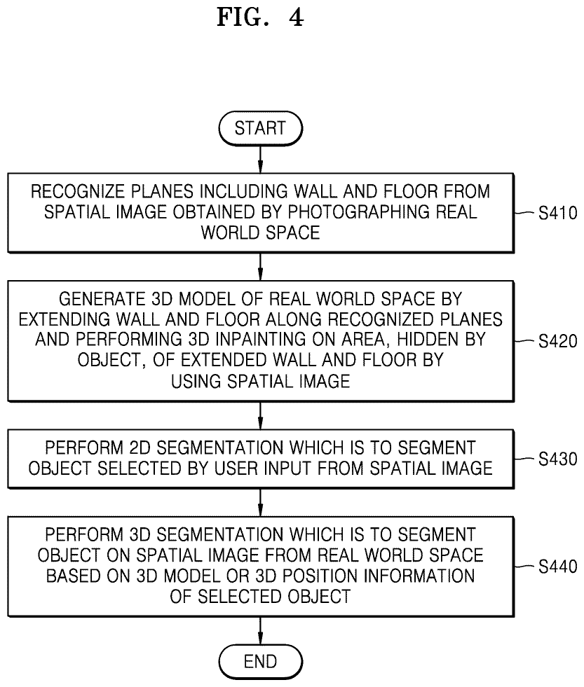

FIG. 4 is a flowchart illustrating an operating method of the augmented reality device 100, according to an embodiment of the present disclosure.

Referring to FIG. 4, in operation S410, the augmented reality device 100 recognizes planes including a wall and a floor from a spatial image obtained by photographing a real world space. In an embodiment of the present disclosure, the augmented reality device 100 may detect a horizontal plane and a vertical plane from the spatial image by using plane detection technology, and may recognize the wall and the floor in the real world space from the detected horizontal plane and vertical plane. However, the present disclosure is not limited thereto, and the augmented reality device 100 may recognize a plane including a window or a door as well as the wall and the floor from the spatial image. In an embodiment of the present disclosure, the augmented reality device 100 may determine whether the recognized plurality of planes are the same plane through position information, and may integrate the plurality of planes into one plane when the plurality of planes are the same plane.

In operation S420, the augmented reality device 100 generates a 3D model of the real world space by extending the wall and the floor along the recognized planes and performing 3D inpainting on an area, hidden by an object, of the extended wall and floor by using the spatial image. In an embodiment of the present disclosure, the augmented reality device 100 may derive a plane equation of each of the recognized wall and floor, and may obtain a 3D model shape of a virtual wall and a virtual floor by extending the wall and the floor based on the derived plane equation. The augmented reality device 100 may identify an object located on the wall and the floor in the real world space from the spatial image. In an embodiment of the present disclosure, the augmented reality device 100 may obtain depth information and color information of the real world space from the spatial image, and may identify an object based on at least one of the obtained depth information and color information. The augmented reality device 100 may inpaint an area hidden by the identified object in the 3D model shape including the virtual wall and the virtual floor. In the present disclosure, ‘inpainting’ refers to an image processing technology that restores a portion of an image that is hidden, lost, or distorted. In an embodiment of the present disclosure, the augmented reality device 100 may inpaint an area, hidden by the object, of the virtual wall and the virtual floor by using information of the spatial image. A specific embodiment in which the augmented reality device 100 generates a 3D model of a real world space through 3D inpainting will be described in detail with reference to FIGS. 5 to 8.

In operation S430, the augmented reality device 100 performs 2D segmentation which is to segment an object selected by a user input from the spatial image. In an embodiment of the present disclosure, the augmented reality device 100 may receive a user input that selects a specific object on the spatial image. For example, the augmented reality device 100 may include a touchscreen including a touch panel, and may receive a touch input of a user who selects a specific object on the spatial image displayed through the touchscreen. The augmented reality device 100 may recognize the object selected by the user input, and may perform segmentation which is to segment the recognized object from the spatial image. In an embodiment of the present disclosure, the augmented reality device 100 may obtain image information, 2D position coordinate information, and depth value information of the object selected by the user input from the spatial image. The augmented reality device 100 may perform 2D segmentation on the object based on at least one of the image information, the 2D position coordinate information, and the depth information of the object, plane information obtained through plane detection, and object distinction information.

In an embodiment of the present disclosure, the augmented reality device 100 may segment the object by using a deep neural network pre-trained to classify objects into labels, classes, or categories.

In operation S440, the augmented reality device 100 performs 3D segmentation which is to segment the object on the spatial image from the real world space based on a 3D model or 3D position information of the selected object. In an embodiment of the present disclosure, when a 3D model of the object selected by the user input is stored in a storage space in the augmented reality device 100, the augmented reality device 100 may load and obtain the pre-stored 3D model, and may perform 3D segmentation which is to segment the object from the spatial image by using the obtained 3D model. In an embodiment of the present disclosure, when a 3D model of the object selected by the user input is not pre-stored, the augmented reality device 100 may perform 3D segmentation which is to segment the object from the spatial image based on at least one of an edge, a feature point, and 3D position coordinate values of pixels of the object obtained from the spatial image.

FIG. 5 is a flowchart illustrating a method by which the augmented reality device 100 generates a 3D model of a real world space, according to an embodiment of the present disclosure.

Operations S510 to S550 of FIG. 5 are detailed operations of operation S420 of FIG. 4. Operation S510 of FIG. 5 may be performed after operation S410 of FIG. 4 is performed. After operation S550 of FIG. 5 is performed, operation S430 of FIG. 4 may be performed.

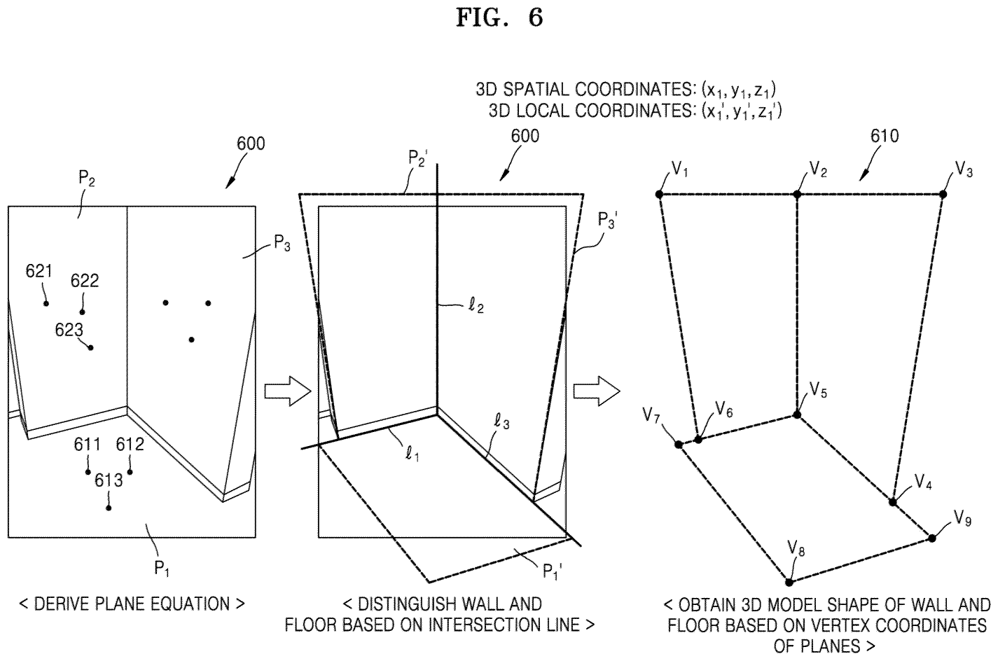

Hereinafter, operations S510 to S550 will be described with reference to embodiments of FIGS. 6 to 8.

In operation S510, the augmented reality device 100 derives a plane equation from each of the planes including the recognized wall and floor. In an embodiment, the augmented reality device 100 may execute an application to start an augmented reality, and may detect a horizontal plane and a vertical plane from the spatial image of the real world space through plane detection technology of the augmented reality session. The augmented reality device 100 may recognize the wall and the floor in the real world space from the detected horizontal plane and vertical plane. In this case, the augmented reality session may include determining whether the real world space is an environment suitable for performing augmented reality space recognition and notifying that the real world space is stably recognized. In an embodiment of the present disclosure, the augmented reality device 100 may determine whether the recognized plurality of planes are the same plane through position information, and may integrate the plurality of planes into one plane when it is determined that the plurality of planes are the same plane.

FIG. 6 is a diagram illustrating an operation in which the augmented reality device 100 obtains a 3D model shape 610 related to shapes of planes (e.g., P₁ to P₃) in a real world space 600, according to an embodiment of the present disclosure. Referring to FIG. 6 together with operation S510 of FIG. 5, the augmented reality device 100 may extract 3D position coordinate values of three points from each of the plurality of planes (e.g., P₁ to P₃) recognized from the spatial image. In an embodiment of the present disclosure, the processor 130 (see FIG. 3) of the augmented reality device 100 may obtain depth value information of a plurality of points from each of the plurality of planes (e.g., P₁ to P₃) recognized through the augmented reality session, and may select three points with a high confidence value. Here, a ‘confidence value’ is calculated by the augmented reality session, and may be calculated based on sensor noise of feature points measured by the IMU sensor 120 (see FIG. 3) when an orientation or a field of view (FOV) of the augmented reality device 100 is changed. For example, as sensor noise is decreases, a confidence value of a feature point may increase. In an embodiment of the present disclosure, when confidence values of points extracted from each of the plurality of points (e.g., P₁ to P₃) are the same, the processor 130 may arbitrarily select three points from among the plurality of points with the same confidence value. Referring to the embodiment of FIG. 6 together, the processor 130 may extract three points 611, 612, and 613 with a high confidence value from a first plane P₁, and may extract three points 621, 622, and 623 from a second plane P₂. Although not shown, the processor 130 may extract three points from a third plane P₃.

The processor 130 may derive a plane equation based on 3D position coordinate values of three points extracted from each of the plurality of planes (e.g., P₁ to P₃). In an embodiment of the present disclosure, in a case that an angle of a point at which the plurality of planes (e.g., P₁ to P₃) meet each other is equal to or less than a threshold value, the processor 130 may determine that the planes are a single plane and may integrate the planes into one plane equation. The processor 130 may obtain a normal vector of the second plane P₂ and the third plane P₃ which are walls by using a measurement value of the IMU sensor 120 (see FIG. 3). The processor 130 may identify whether an angle of 90° is formed between the obtained normal vector of the wall and a normal vector of the first plane P₁ that is a floor In a case that an angle formed between the normal vector of the first plane P₁ which is the floor and the normal vector of the second plane P₂ and the third plane P₃ which are the walls differs by ±3° to ±5° from 90°, the processor 130 may perform plane detection again.

Referring back to FIG. 5, in operation S520, the augmented reality device 100 obtains a 3D model shape of a virtual wall and a virtual floor, by extending the wall and the floor based on the plane equation. Referring to FIG. 6 together, the processor 130 of the augmented reality device 100 may generate virtual planes (e.g., P₁′, P₂′, and P₃′) by extending the plurality of planes (e.g., P₁, P₂, and P₃) through the plane equation. For example, the first plane P₁ which is the floor may be extended to a virtual floor P₁′, and the second plane P₂ and the third plane P₃ which are the walls may be extended to virtual walls P₂′ and P₃′. In an embodiment of the present disclosure, the processor 130 may extract intersection lines 1₁, 1₂, and 1₃ at which the extended virtual planes (e.g., P₁′, P₂′, and P₃′) meet each other, and may distinguish the virtual floor P₁′ and the virtual walls P₂′ and P₃′ based on the extracted intersection lines 1₁, 1₂, and 1₃. The processor 130 may obtain vertex coordinates V₁ to V₉ of the distinguished virtual planes (e.g., P₁′, P₂′, and P₃′), and may obtain the 3D model shape 610 including the virtual floor P₁′ and the virtual walls P₂′ and P₃′ based on the obtained vertex coordinates V₁ to V₉.

The processor 130 may store the 3D model shape in a storage space in the augmented reality device 100. In an embodiment of the present disclosure, the processor 130 may store the 3D model shape 610 and position information in the 3D model database 148 (see FIG. 3) in the memory 140 (see FIG. 3).

Referring back to FIG. 5, in operation S530, the augmented reality device 100 identifies an object located on the wall and the floor in the real world space from the spatial image. In an embodiment of the present disclosure, the augmented reality device 100 may distinguish each wall, floor, and object by using depth information and color information based on plane detection information of the wall and the floor.

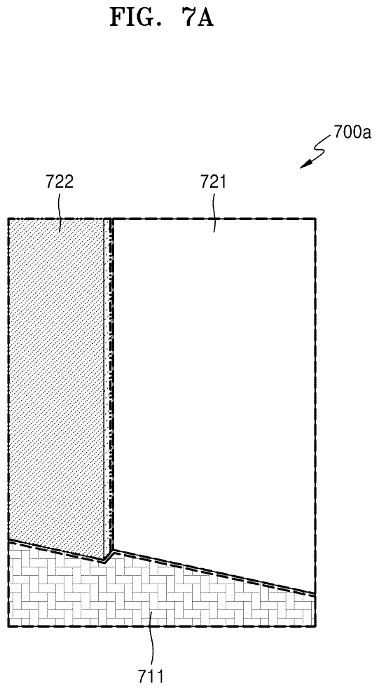

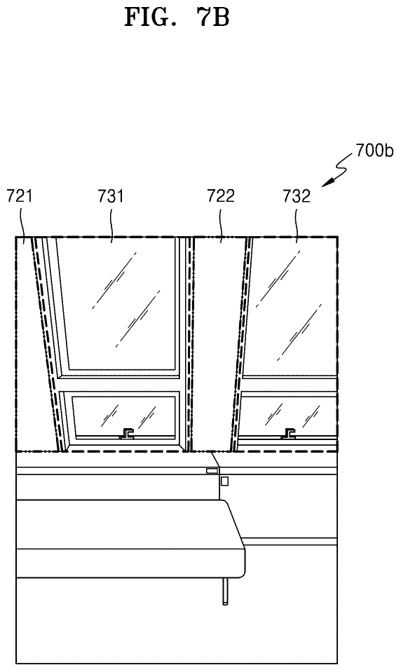

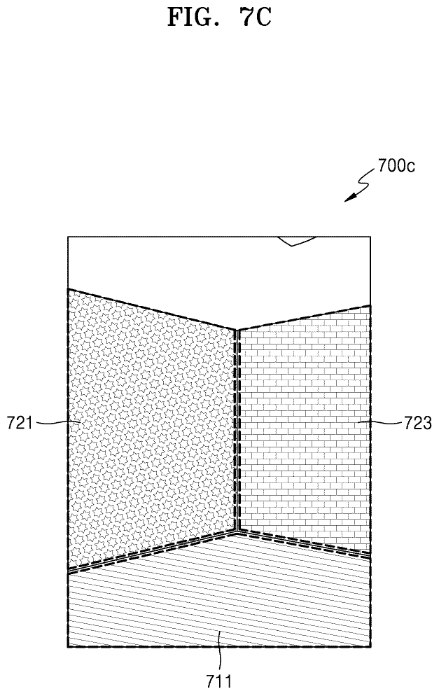

FIG. 7A is a diagram illustrating an operation in which the augmented reality device 100 distinguishes planes of a wall and a floor on a spatial image 700a, according to an embodiment of the present disclosure. Referring to operation S530 of FIG. 5 together with FIG. 7A, the processor 130 of the augmented reality device 100 may recognize a plurality of planes (e.g., 711, 721, and 722) by using plane detection technology, and may distinguish a floor surface 711 and wall surfaces 721 and 722 from among the plurality of planes (e.g., 711, 721, and 722) based on color information obtained from the spatial image 700a.

FIG. 7B is a diagram illustrating an operation in which the augmented reality device 100 distinguishes planes of a wall and a window on a spatial image 700b, according to an embodiment of the present disclosure. Referring to operation S530 of FIG. 5 together with FIG. 7B, the processor 130 of the augmented reality device 100 may recognize a plurality of planes (e.g., 721, 722, 731, and 732) from the spatial image 700b by using plane detection technology, and may distinguish wall surfaces 721 and 722 and windows 731 and 732 based on depth information of a real world space and color information of the spatial image 700b.

FIG. 7C is a diagram illustrating an operation in which the augmented reality device 100 distinguishes planes of a wall and a floor with different patterns on a spatial image 700c, according to an embodiment of the present disclosure. Referring to operation S530 of FIG. 5 together with FIG. 7C, the processor 130 of the augmented reality device 100 may recognize a plurality of planes (e.g., 711, 721, and 723) from the spatial image 700c by using plane detection technology, and may recognize a floor surface 711 and wall surfaces 721 and 723 based on depth information of a real world space. The processor 130 may obtain color information of the spatial image 700c, and may distinguish the wall surfaces 721 and 723 with different patterns based on the obtained color information.

The processor 130 of the augmented reality device 100 may obtain a 3D position coordinate value of the real world space through an augmented reality session, and in a case that a depth value including z-axis coordinate information is not identified as the wall and the floor, may determine that the depth value corresponds to an object. In an embodiment of the present disclosure, in a case that it is difficult to identify an object by using depth information, the processor 130 may identify an object by using color information obtained from the spatial image.

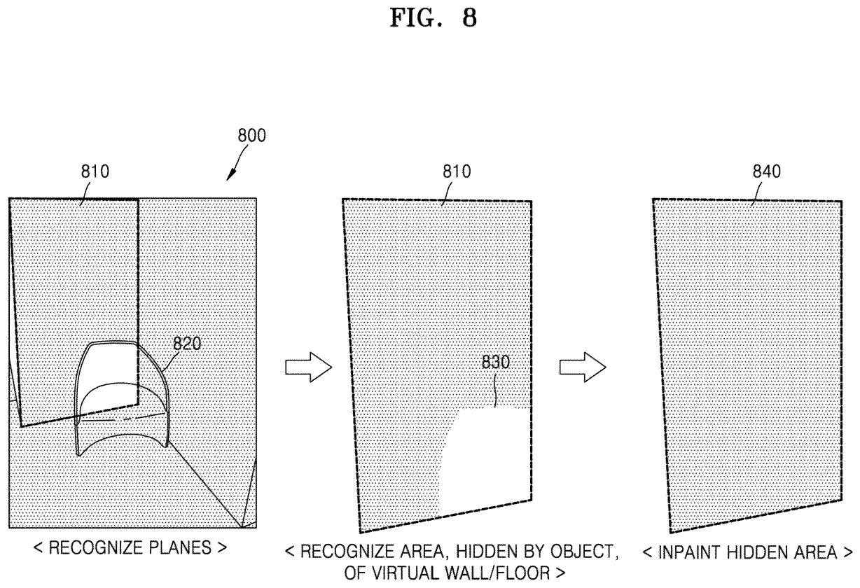

FIG. 8 is a diagram illustrating an operation in which the augmented reality device 100 performs 3D inpainting, according to an embodiment of the present disclosure. Referring to operation S530 of FIG. 5 together with FIG. 8, the processor 130 of the augmented reality device 100 may obtain a spatial image 800 of a real world space through an augmented reality session, and may recognize a wall surface 810 and an object 820 from the spatial image 800. The processor 130 may obtain a 3D position coordinate value of the real world space, and may identify an area whose depth value, which is z-axis coordinate information, is different from the wall surface 810 as the object 820. In an embodiment of the present disclosure, the processor 130 may obtain color information of the spatial image 800, and may identify an area with a color significantly different from a color of the wall surface 810 as the object 820. In the embodiment of FIG. 8, the processor 130 may distinguish the wall surface 810 and the object 820 (e.g., chair) based on depth information of the real world space and color information of the spatial image 800.

Referring back to FIG. 5, in operation S540, the augmented reality device 100 inpaints an area, hidden by the object, of the wall and the floor by using information of the spatial image. The augmented reality device 100 may identify the area hidden by the object on the wall and the floor of the spatial image. Referring to FIG. 8 together, the processor 130 of the augmented reality device 100 may identify an area 830 hidden by the object from the spatial image 800. The processor 130 may inpaint the area 830, hidden by the object, among areas of the wall and the floor by using color information of the spatial image 800. In the present disclosure, ‘inpainting’ refers to an image processing technology that restores a portion of an image that is hidden, lost, or distorted.

The processor 130 may inpaint the hidden area 830 in the 3D model shape by using images of wall and floor portions. In an embodiment of the present disclosure, the processor 130 may perform inpainting separately on each of the wall and the floor. In a case that a window is recognized separately from the wall and the floor, the processor 130 may perform inpainting separately on each of the wall, the floor, and the window. In the embodiment of FIG. 8, the processor 130 may inpaint the area 830 hidden by the object by using color information of the wall surface 810 of the spatial image 800, and may obtain an inpainted image 840.

The processor 130 may inpaint an area corresponding to the area 830 hidden by the object on the virtual wall and the virtual floor of the 3D model shape by combining the images of wall and floor portions with a virtual image.

Referring back to FIG. 5, in operation S550, the augmented reality device 100 generates a 3D model of the real world space by applying a texture of an inpainted image to the 3D model shape of the virtual wall and the virtual floor. Referring to FIG. 8 together, the processor 130 of the augmented reality device 100 may perform image processing of applying the inpainted image 840 as a texture to the generated 3D model shape. For example, the processor 130 may generate a 3D model of the real world space by applying the in paining image 840 to the 3D model shape obtained in operation S520.

In an embodiment of the present disclosure, the augmented reality device 100 may store the 3D model generated through inpainting in the storage device (e.g., the 3D model database 148 (see FIG. 3) in the memory 140 of FIG. 3)).

FIG. 9 is a diagram illustrating an operation in which the augmented reality device 100 performs 2D segmentation from a spatial image 900, according to an embodiment of the present disclosure.

Referring to FIG. 9, the augmented reality device 100 may execute an augmented reality application to start an augmented reality session, and may obtain a spatial image 920 by photographing a real world space 10 by using the camera 110 (see FIG. 3). The augmented reality device 100 may obtain 3D position information of the real world space 10, and may recognize a wall, a floor, and an object by using plane detection technology. In this case, the augmented reality session may include determining whether the real world space is an environment suitable for performing augmented reality space recognition, and notifying that the real world space is stably recognized.

The augmented reality device 100 may obtain the 3D position information of the real world space 10 through the augmented reality session, and may obtain a depth map 910 including depth information that is a z-axis coordinate value from among 3D position coordinate values.

The augmented reality device 100 may recognize planes (e.g., P₁, P₂, and P₃) of the wall and the floor by using plane detection technology, and may obtain a 3D model shape 930 by extending the recognized planes (e.g., P₁, P₂, and P₃). A specific method by which the augmented reality device 100 obtains the 3D model shape 930 is the same as the method described with reference to FIGS. 5 and 6, and thus, a repeated description thereof will be omitted.

The augmented reality device 100 may receive a user input that selects a specific object on the spatial image displayed through the display unit 150. In an embodiment of the present disclosure, the display unit 150 may include a touchscreen, and the augmented reality device 100 may receive a touch input of a user who selects a specific object in the spatial image 920 displayed through the touchscreen. In an embodiment of FIG. 9, the augmented reality device 100 may receive a touch input of a user who selects a table in the spatial image 920.

In response to a user input that selects an object being received, the processor 130 (see FIG. 3) of the augmented reality device 100 may obtain image information of the object selected by the user input, depth information (depth map data representing depth values of pixels constituting the object as a 2D image), 2D position coordinate value information (x-axis and y-axis coordinate values) on the spatial image 920 of the selected object, and 2D position coordinate value information (x-axis and y-axis coordinate values) and 3D position coordinate value information (x-axis, y-axis, and z-axis coordinate values) of main feature points (AR feature points). The processor 130 may recognize the planes (e.g., P₁, P₂, and P₃) of the wall and the floor by using plane detection technology, may identify objects such as furniture or a home appliance in the real world space based on depth information, and may recognize a position relationship between the identified objects and the wall and floor.

The augmented reality device 100 may perform 2D segmentation on the object selected by the user input, by using depth information of the depth map 910, the spatial image 920, 2D position coordinates of the object selected by the user, and wall, floor and wall distinction information obtained from the 3D model shape 930. Here, ‘2D segmentation’ refers to an image processing technology that distinguishes an object with other objects or a background image in an image and segments a 2D outlier of the object from the image. In an embodiment of the present disclosure, 2D segmentation may include not only segmenting a 2D outline of an object but also classifying the object into classes or categories and distinguishing the object from other objects or a background image in an image according to a classification result.

In an embodiment of the present disclosure, the processor 130 of the augmented reality device 100 may input at least one of depth information of the depth map 910, image information of the spatial image 920, 2D position coordinate information of the object, and object distinction information to a pre-trained deep neural network model 940, and may perform 2D segmentation on the object by performing inference using the deep neural network model 940. The deep neural network model 940 may be an AI model including model parameters pre-trained by applying tens of thousands to hundreds of millions of images as input data and applying a label value of an object included in an image as a ground truth. In an embodiment of the present disclosure, the deep neural network model 940 may be an AI model pre-trained for each furniture, each home appliance, or for each category within furniture such as a chair or a sofa. The deep neural network model 940 may include at least one of a convolutional neural network (CNN), a recurrent neural network (RNN), a restricted Boltzmann machine (RBM), a deep belief network (DBN), bidirectional recurrent deep neural network (BRDNN), and a deep Q-network.

The processor 130 may obtain a segmentation image 950 in which a 2D outline of an object 952 is segmented from other objects or a background image through inference using the deep neural network model 940.

FIG. 10 is a flowchart illustrating a method by which the augmented reality device 100 performs 3D segmentation based on whether a 3D model of an object is stored, according to an embodiment of the present disclosure.

Operations S1010 to S1070 of FIG. 10 are detailed operations of operation S440 of FIG. 4. Operation S1010 of FIG. 10 may be performed after operation S430 of FIG. 4 is performed.

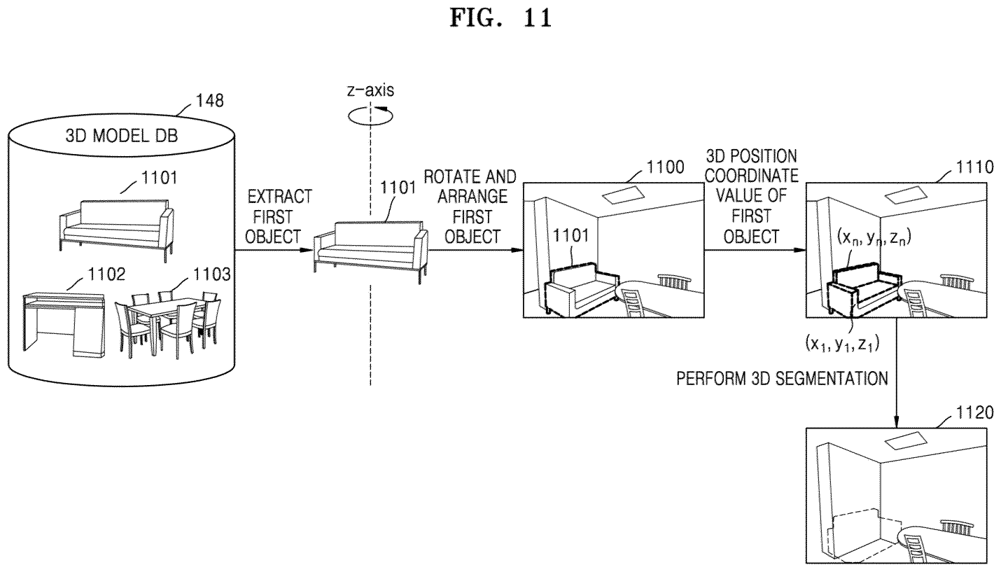

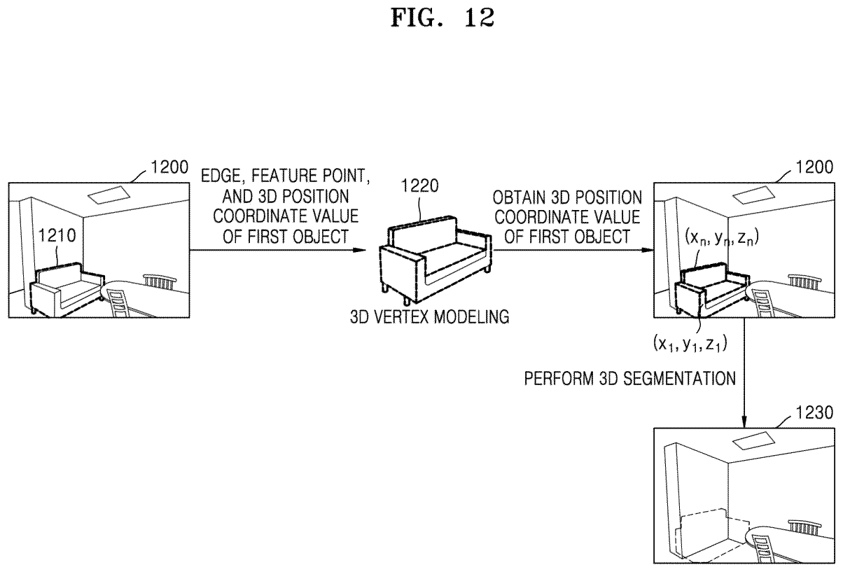

In operation S1010, the augmented reality device 100 determines whether there is a pre-stored 3D model of an object. The processor 130 (see FIG. 3) of the augmented reality device 100 may determine whether a 3D model of the object selected by the user input is stored in the storage space in the memory 140 (see FIG. 3). A 3D segmentation method of FIG. 10 may be performed differently according to whether a 3D model of an object is pre-stored. An embodiment in which a 3D model of an object is pre-stored will be described with reference to FIG. 11, and an embodiment in which a 3D model of an object is not stored will be described with reference to FIG. 12.

When the 3D model of an object is pre-stored (operation S1020), the augmented reality device 100 arranges the 3D model to overlap a 2D segmentation outlier on the spatial image, by adjusting a direction of the 3D model. FIG. 11 is a diagram illustrating an operation in which the augmented reality device 100 performs 3D segmentation by using a pre-stored 3D model of an object, according to an embodiment of the present disclosure. Referring to operation S1020 of FIG. 10 together with FIG. 11, 3D models 1101 to 1103 of a plurality of objects may be stored in the 3D model database 148. The processor 130 (see FIG. 3) of the augmented reality device 100 may identify the 3D model 1101 of a first object selected by a user input from among the 3D models 1101 to 1103 of the plurality of objects pre-stored in the 3D model database 148, and may load the identified 3D model 1101 of the first object from the 3D model database 148. The processor 130 may rotate the loaded 3D model 1101 of the first object along the Z-axis until the 3D model 1101 is the same as a shape of a 2D outline generated in a spatial image 1100 according to a 2D segmentation result. In this case, a resolution of a rotation angle may be freely determined according to required accuracy. The processor 130 may arrange the 3D model 1101 of the first object whose orientation is adjusted according to a rotation result on the 2D outline on the spatial image 1100.

Referring back to FIG. 10, in operation S1030, the augmented reality device 100 obtains a 3D position coordinate value of the object from the arranged 3D model. Referring to FIG. 11 together, the 3D model 1101 of the first object may be arranged to fit the 2D outline on the spatial image 1100, and 3D position coordinate values of a plurality of feature points constituting the first object may be obtained according to an arrangement result.

Referring to FIG. 10, in operation S1040, the augmented reality device 100 performs 3D segmentation which is to segment the object from the spatial image based on the obtained 3D position coordinate value. Referring to FIG. 11 together, the processor 130 of the augmented reality device 100 may obtain a segmentation image 1120 in which the first object is segmented from an image of a real world space based on the 3D position coordinate values of the plurality of feature points constituting the first object.

Referring back to FIG. 10, when a 3D model of the object is not stored (operation S1050), the augmented reality device 100 obtains an edge, a feature point, and 3D position coordinate values of pixels of the object recognized from the spatial image. FIG. 12 is a diagram illustrating an operation in which the augmented reality device 100 performs 3D segmentation when a 3D model of an object is not stored, according to an embodiment of the present disclosure. Referring to operation S1050 of FIG. 10 together with FIG. 12, the processor 130 of the augmented reality device 100 may obtain an edge, a feature point, and 3D position coordinate values of pixels constituting a first object 1210 selected by a user input in a spatial image 1200.

Referring back to operation S1060 of FIG. 10, the augmented reality device 100 performs 3D vertex modeling based on at least one of the edge, the feature point, and the 3D position coordinate values of the pixels of the object. Referring to FIG. 12 together, the processor 130 of the augmented reality device 100 may input the edge, the feature point, and the 3D position coordinate values of the pixels of the object to a pre-trained deep learning neural network, and may perform 3D vertex modeling by using the deep neural network model. The deep neural network model may be an AI model that is pre-trained for each furniture, each home appliance, or each category within furniture such as a chair or a sofa. The deep neural network model may include at least one of a convolutional neural network (CNN), a recurrent neural network (RNN), a restricted Boltzmann machine (RBM), a deep belief network (DBN), bidirectional recurrent deep neural network (BRDNN), and a deep Q-network. However, the deep neural network model of the present disclosure is not limited to the above examples.

Referring back to operation S1070 of FIG. 10, the augmented reality device 100 performs 3D segmentation which is to segment the object from the spatial image through 3D vertex modeling. Referring to FIG. 12 together, the processor 130 of the augmented reality device 100 may obtain a 3D position coordinate value of a first object 1220 through 3D vertex modeling. The processor 130 may obtain a segmentation image 1230 in which the first object 1220 is segmented from the spatial image 1200 based on 3D position coordinate values of a plurality of pixels constituting the first object 1220.

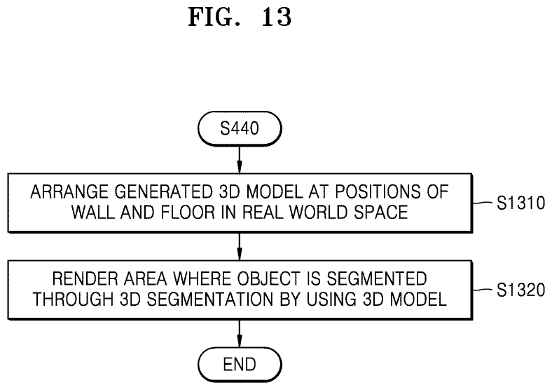

FIG. 13 is a flowchart illustrating a method by which the augmented reality device 100 arranges a 3D model in a real world space and performs rendering by using the 3D model, according to an embodiment of the present disclosure.

Operation S1310 of FIG. 13 may be performed after operation S440 of FIG. 4 is performed.

In operation S1310, the augmented reality device 100 arranges a generated 3D model at positions of a wall and a floor in a real world space.

In operation S1320, the augmented reality device 100 renders an area where an object is segmented through 3D segmentation by using the 3D model. When an object selected by a user input is segmented through 3D segmentation, the augmented reality device 100 may render an area deleted due to the 3D segmentation by using the 3D model. In an embodiment of the present disclosure, the augmented reality device 100 may perform rendering after deleting an original image of the area where the 3D segmentation is performed. However, the present disclosure is not limited thereto, and in an embodiment of the present disclosure, the augmented reality device 100 may simply render a 3D model of the wall and the floor and may arrange the 3D model on an object of the real world space, without needing to delete the area where the 3D segmentation is performed. In this case, the augmented reality device 100 may set a depth testing value so that a real world object is rendered on the 3D model by adjusting a depth value between the 3D model and the object.

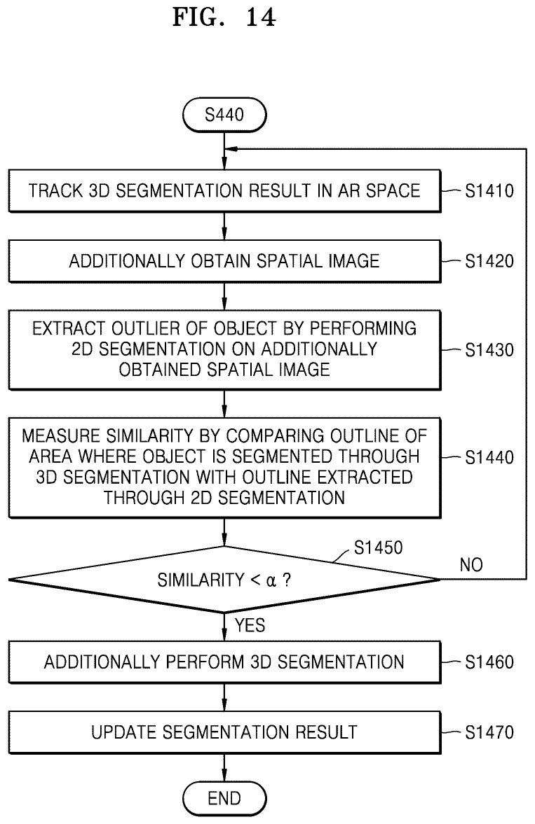

FIG. 14 is a flowchart illustrating a method by which the augmented reality device 100 additionally performs 3D segmentation and updates a segmentation result, according to an embodiment of the present disclosure.

Operation S1410 of FIG. 14 may be performed after operation S440 of FIG. 4 is performed.

In operation S1410, the augmented reality device 100 tracks a 3D segmentation result in an augmented reality space. In an embodiment of the present disclosure, in a case that an orientation or a field of view (FOV) of the augmented reality device 100 is changed by a user's manipulation, the augmented reality device 100 may track an area that is segmented through 3D segmentation in the augmented reality space by using a measurement value of the IMU sensor 120 (see FIG. 3). Real-time 3D segmentation of an object is possible through a tracking operation.

In operation S1420, the augmented reality device 100 additionally obtains a spatial image of the real world space. The augmented reality device 100 may execute an augmented reality application to photograph a real world space through the camera 110 (see FIG. 3) and additionally obtain a spatial image. In an embodiment of the present disclosure, the augmented reality device 100 may periodically obtain the spatial image at a preset time interval.

In operation S1430, the augmented reality device 100 extracts an outlier of an object by performing 2D segmentation on the additionally obtained spatial image. An operation in which the augmented reality device 100 extracts an outline of an object by performing 2D segmentation is the same as the operation described with reference to FIG. 9, and thus, a repeated description thereof will be omitted.

In operation S1440, the augmented reality device 110 measures a similarity by comparing an outline of an area where the object is segmented through 3D segmentation with the outline extracted through the 2D segmentation.

In operation S1450, the augmented reality device 100 compares the measured similarity with a preset threshold value α.

In a case that the measured similarity is less than the threshold value α (operation S1460), the augmented reality device 100 additionally performs 3D segmentation. In a case that the similarity is less than the threshold value α, the augmented reality device 100 may recognize that an error has occurred in a 3D segmentation result due to the change in the orientation or the FOV.

In operation S1470, the augmented reality device 100 updates a segmentation result through the additionally performed 3D segmentation.

In a case that the measured similarity exceeds the preset threshold value α, the augmented reality device 100 may return to operation S1420 and may repeatedly perform an operation of additionally obtaining the spatial image.

The present disclosure provides the augmented reality device 100 for providing an augmented reality service for controlling an object in a real world space. The augmented reality device 100 according to an embodiment of the present disclosure may include the camera 110 (see FIG. 3), the IMU sensor 120 (see FIG. 3) including the accelerometer 122 (see FIG. 3) and the gyro sensor 124 (see FIG. 3), the memory 140 (see FIG. 3) in which at least one instruction is stored, and at least one processor 130 (see FIG. 3) configured to execute the at least one instruction. The at least one processor 130 may obtain a spatial image by photographing a real world space using the camera 110. The at least one processor 130 may recognize planes including a wall and a floor from the obtained spatial image. The at least one processor 130 may generate a 3D model of the real world space by extending the wall and the floor along the recognized planes and performing 3D inpainting on an area, hidden by an object, of the extended wall and floor by using the spatial image. The at least one processor 130 may perform 2D segmentation which is to segment an object selected by a user input from the spatial image. The at least one processor 130 may perform 3D segmentation which is to segment the object on the spatial image from the real world space based on a 3D model or 3D position information of the object.

In an embodiment of the present disclosure, the at least one processor 130 may arrange the generated 3D model at positions of the wall and the floor in the real world space, and may render an area where the object is segmented through the 3D segmentation by using the 3D model.

In an embodiment of the present disclosure, the at least one processor 130 may derive a plane equation from each of the planes including the recognized wall and floor. The at least one processor 130 may obtain a 3D model shape of a virtual wall and a virtual floor, by extending the wall and the floor based on the derived plane equation. The at least one processor 130 may identify an object located on the wall and the floor in the real world space from the spatial image. The at least one processor 130 may inpaint an area, hidden by the identified object, of the wall and the floor by using information of the spatial image. The at least one processor 130 may generate a 3D model of the real world space by applying a texture of an inpainted image to the 3D model shape of the virtual wall and the virtual floor.

In an embodiment of the present disclosure, the at least one processor 130 may extract an intersection line where the extended wall and floor meet each other, and may distinguish the planes of the wall and the floor based on the extracted intersection line. The at least one processor 130 may obtain vertex coordinates of each of the distinguished planes, and may generate the 3D model shape of the virtual wall and the virtual floor based on the obtained vertex coordinates.

In an embodiment of the present disclosure, the at least one processor 130 may identify an object based on at least one of depth information and color information of the real world space obtained from the spatial image. The at least one processor 130 may distinguish the recognized wall and floor from the identified object.

In an embodiment of the present disclosure, the at least one processor 130 may store the generated 3D model in a storage space in the memory 140.

In an embodiment of the present disclosure, the at least one processor 130 may determine whether a 3D model of the selected model is pre-stored in the memory 140, and in a case that it is determined that the 3D model of the selected object is stored, the at least one processor 130 may arrange the 3D model to overlap a 2D outlier on the spatial image by adjusting a direction of the pre-stored 3D model. The at least one processor 130 may obtain a 3D position coordinate value of the object from the arranged 3D model. The at least one processor 130 may perform 3D segmentation which is to segment the object from the spatial image based on the obtained 3D position coordinate value.

In an embodiment of the present disclosure, the at least one processor 130 may determine whether a 3D model of the selected model is stored in the memory 140, and may obtain an edge, a feature point, and 3D position coordinate values of pixels of the object recognized from the spatial image in a case that it is determined that the 3D model of the selected object is not stored. The at least one processor 130 may perform 3D vertex modeling based on at least one of the obtained edge, feature point, and 3D position coordinate values of the pixels of the object. The at least one processor 130 may perform 3D segmentation which is to segment the object from the spatial image through 3D vertex modeling.

In an embodiment of the present disclosure, the at least one processor 130 may additionally obtain a spatial image when an orientation or a field of view of the augmented reality device 100 is changed, and may extract an outline of an object by performing 2D segmentation on the additionally obtained spatial image. The at least one processor 130 may measure a similarity by comparing a 2D outline of an area where the object is segmented through 3D segmentation with the extracted outline. The at least one processor 130 may determine whether to additionally perform 3D segmentation by comparing the similarity with a preset threshold value.

In an embodiment of the present disclosure, in a case that the similarity is less than the threshold value, the at least one processor 130 may additionally perform 3D segmentation and may update a segmentation result through the additionally performed 3D segmentation.

The present disclosure provides a method, performed by the augmented reality device 100, for providing an augmented reality for controlling an object in a real world space. The method may include operation S410 of recognizing planes including a wall and a floor from a spatial image obtained by photographing a real world space using the camera 110. The method may include operation S420 of generating a 3D model of the real world space by extending the wall and the floor along the recognized planes and performing 3D inpainting on an area, hidden by an object, of the extended wall and floor by using the spatial image. The method may include operation S430 of performing 2D segmentation which is to segment an object selected by a user input from the spatial image. The method may include operation S440 of performing 3D segmentation which is to segment the object on the spatial image from the real world space based on a 3D model or 3D position information of the object.

In an embodiment of the present disclosure, the method may further include operation S1310 of arranging the generated 3D model at positions of the wall and the floor in the real world space and operation S1320 of rendering an area where the object is segmented through the 3D segmentation by using the 3D model.

In an embodiment of the present disclosure, operation S420 of generating the 3D model of the real world space may include operation S510 of deriving a plane equation from each of the planes including the recognized wall and floor. Operation S420 of generating the 3D model of the real world space may include operation S520 of obtaining a 3D model shape of a virtual wall and a virtual floor, by extending the wall and the floor based on the derived plane equation. Operation S420 of generating the 3D model of the real world space may include operation S530 of identifying an object located on the wall and the floor in the real world space from the spatial image. Operation S420 of generating the 3D model of the real world space may include operation S540 of inpainting an area, hidden by the identified object, of the wall and the floor by using information of the spatial image. Operation S420 of generating the 3D model of the real world space may include operation S550 of generating the 3D model of the real world space by applying a texture of an inpainted image to the 3D model shape of the virtual wall and the virtual floor.

In an embodiment of the present disclosure, operation S520 of generating the 3D model shape of the virtual wall and the virtual floor may include extracting an intersection line where the extended wall and floor meet each other, distinguishing the planes of the wall and the floor based on the extracted intersection line, obtaining vertex coordinates of each of the distinguished planes, and generating the 3D model shape of the virtual wall and the virtual floor based on the obtained vertex coordinates.

In an embodiment of the present disclosure, operation S530 of identifying the object located on the wall and the floor in the real world space may include identifying the object based on at least one of depth information and color information of the real world space obtained from the spatial image and distinguishing the recognized wall and floor from the identified object.

Operation S440 of performing the 3D segmentation may include operation S1010 of determining whether a 3D model of the selected object is pre-stored, and operation S1020 of arranging the 3D model to overlap a 2D segmentation outlier on the spatial image by adjusting a direction of the pre-stored 3D model in a case that it is determined that the 3D model of the selected object is pre-stored. Operation S440 of performing the 3D segmentation may include operation S1030 of obtaining a 3D position coordinate value of the object from the arranged 3D model. Operation S440 of performing the 3D segmentation may include operation S1040 of performing 3D segmentation which is to segment the object from the spatial image based on the obtained 3D position coordinate value.

In an embodiment of the present disclosure, operation S440 of performing the 3D segmentation may include operation S1010 of determining whether a 3D model of the selected object is pre-stored, and operation S1050 of obtaining an edge, a feature point, and 3D position coordinate values of pixels of the object recognized from the spatial image in a case that it is determined that the 3D model of the selected object is not stored. Operation S440 of performing the 3D segmentation may include operation S1060 of performing 3D vertex modeling based on at least one of the obtained edge, feature point, and the 3D position coordinate values of the pixels of the object. Operation S440 of performing the 3D segmentation may include operation S1070 of performing 3D segmentation which is to segment the object from the spatial image through 3D vertex modeling.

In an embodiment of the present disclosure, the method may further include operation S1420 of additionally obtaining a spatial image in a case that an orientation or a field of view (FOV) of the augmented reality device 100 is changed, and extracting an outline of the object by performing 2D segmentation on the additionally obtained spatial image. The method may further include operation S1430 of measuring a similarity by comparing a 2D outline of an area where the object is segmented through the 3D segmentation with the extracted outline. The method may further include operation S1440 of determining whether to additionally perform 3D segmentation by comparing the similarity with a preset threshold value.

In an embodiment of the present disclosure, the method may further include, when the similarity is less than the threshold value, operation S1460 of additionally performing 3D segmentation and updating a segmentation result through the additionally performed 3D segmentation. The updating of the segmentation result may be periodically performed at a preset interval.

The present disclosure provides a computer program product including a computer-readable storage medium. The storage medium may include instructions readable by the augmented reality device 100 to enable the augmented reality device 100 to recognize planes including a wall and a floor from a spatial image obtained by photographing a real world space using the camera 110, generate a 3D model of the real world space by extending the wall and the floor along the recognized planes and performing 3D inpainting on an area, hidden by an object, of the extended wall and floor by using the spatial image, perform 2D segmentation which is to segment an object selected by a user input from the spatial image, and perform 3D segmentation which is to segment the object on the spatial image from the real world space based on a 3D model or 3D position information of the object.

A program executed by the augmented reality device 100 described in the present disclosure may be implemented as a hardware component, a software component, and/or a combination of hardware and software components. The program may be executed by any system capable of executing computer-readable instructions.

Software may include a computer program, code, instructions, or a combination of one or more thereof, and may configure a processing device to operate as desired or instruct the processing device independently or collectively.

The software may be implemented as a computer program including instructions stored in a computer-readable storage medium. Examples of the computer-readable recording medium include a magnetic storage medium (e.g., a read-only memory (ROM), a random-access memory (RAM), a floppy disk, or a hard disk) and an optical recording medium (e.g., a compact disc ROM (CD-ROM) or a digital versatile disc (DVD)). The computer-readable recording medium may be distributed in computer systems connected in a network so that computer-readable code is stored and executed in a distributed fashion. The medium may be computer-readable, may be stored in a memory, and may be executed by a processor.

The computer-readable storage medium may be provided in the form of a non-transitory storage medium. In this case, “non-transitory” means that the storage medium does not include a signal and is tangible but does not distinguish whether data is semi-permanently or temporarily stored in the storage medium. For example, the “non-transitory storage medium” may include a buffer in which data is temporarily stored.

Also, a program according to embodiments of the present disclosure may be provided in a computer program product. The computer program product may be able to be traded, as a product, between a seller and a purchaser.

The computer program product may include a software program and a computer-readable storage medium in which the software program is stored. For example, the computer program product may include a software program-type product (e.g., a downloadable application) that is electronically distributed through an electronic market (e.g., Samsung Galaxy Store) or a manufacturer of an augmented reality device 100. For electronic distribution, at least a part of the software program may be stored in a storage medium or may be temporarily generated. In this case, the storage medium may be a server of the manufacturer of the augmented reality device 100, a server of the electronic market, or a storage medium of a relay server temporarily storing the software program.

The computer program product may include a storage medium of a server or a storage medium of the augmented reality device 100 in a system including the server and/or the augmented reality device 100. Alternatively, when there is a third device (e.g., a wearable device) communicatively connected to the augmented reality device 100, the computer program product may include a storage medium of the third device. Alternatively, the computer program product may include a software program transmitted from the augmented reality device 100 to the third device, or transmitted from the third device to the electronic device.

In this case, one of the augmented reality device 100 or the third device may execute the computer program product to perform a method according to disclosed embodiments. Alternatively, at least one of the augmented reality device 100 and the third device may execute the computer program product to perform the method according to the disclosed embodiments in a distributed fashion.

For example, the augmented reality device 100 may execute the computer program product stored in the memory 140 (see FIG. 3) to control another electronic device (e.g., a wearable device) communicatively connected to the augmented reality device 100 to perform the method according to the disclosed embodiments.

In another example, the third device may execute the computer program product to control an electronic device communicatively connected to the third device to perform the method according to the disclosed embodiments.

In a case that the third device executes the computer program product, the third device may download the computer program product from the augmented reality device 100 and may execute the downloaded computer program product. Alternatively, the third device may execute the computer program product provided in a pre-loaded state to perform the method according to the disclosed embodiments.

Although the embodiments have been described by the limited embodiments and the drawings as described above, various modifications and variations are possible by one of ordinary skill in the art from the above description. For example, the described techniques may be performed in a different order from the described method, and/or the described elements such as a computer system and a module may be combined or integrated in a different form from the described method, or may be replaced or substituted by other elements or equivalents to achieve appropriate results.

What is claimed is:

1. An augmented reality device comprising:
a camera;
at least one processor including processing circuitry;
memory storing one or more instructions; and
wherein the one or more instructions are configured to, when executed by the at least one processor individually or collectively, cause the augmented reality device to:
obtain, through the camera, a spatial image based on a photograph of a real world space,
identify a first plane comprising a wall and a second plane comprising a floor from the spatial image,
generate a three-dimensional (3D) model of the real world space by extending the wall and extending the floor along their respective planes and performing 3D inpainting on an area of the extended wall and the extended floor that is hidden by an obstructive object,
segment an object selected by a user input from the spatial image based on two-dimensional (2D) segmentation, and
segment the object on the spatial image from the real world space based on a 3D model or 3D position information of the object using 3D segmentation.

2. The augmented reality device of claim 1, wherein the one or more instructions are configured to, when executed by the at least one processor individually or collectively, further cause the augmented reality device to:
orient the 3D model based on positions of the wall and the floor in the real world space, and
render an area in the 3D model where the object is segmented based on the 3D segmentation.

3. The augmented reality device of claim 1, wherein the one or more instructions are configured to, when executed by the at least one processor individually or collectively, further cause the augmented reality device to:
obtain a plane equation based on the first plane and the second plane,
obtain a 3D model shape of a virtual wall and a virtual floor, by extending the wall and the floor based on the plane equation,
identify the object located on the wall and the floor in the real world space from the spatial image,
inpaint the area of the wall and the floor that is hidden by the object based on the spatial image, and
generate the 3D model of the real world space by applying a texture of an inpainted image to the 3D model shape of the virtual wall and the virtual floor.

4. The augmented reality device of claim 3, wherein the one or more instructions are configured to, when executed by the at least one processor individually or collectively, further cause the augmented reality device to:
extract an intersection line where the extended wall and the extended floor meet each other,
determine the first plane and the second plane based on the intersection line,
obtain vertex coordinates of the first plane and the second plane, and
generate the 3D model shape of the virtual wall and the virtual floor based on the vertex coordinates.

5. The augmented reality device of claim 3, wherein the one or more instructions are configured to, when executed by the at least one processor individually or collectively, further cause the augmented reality device to:
identify the object based on at least one of depth information of the real world space and color information of the real world space, and
distinguish the wall and the floor from the object.

6. The augmented reality device of claim 1, wherein the one or more instructions are configured to, when executed by the at least one processor individually or collectively, further cause the augmented reality device to:
determine whether a 3D model of the object is pre-stored in the memory, and
based on determining that the 3D model of the object is stored, orient the 3D model to overlap a 2D segmentation outlier on the spatial image based on a direction of the 3D model of the object,
obtain a 3D position coordinate value of the object from the 3D model, and
segment the object from the spatial image based on the 3D position coordinate value based on 3D segmentation.

7. The augmented reality device of claim 1, wherein the one or more instructions are configured to, when executed by the at least one processor individually or collectively, further cause the augmented reality device to:
determine whether a 3D model of the object is stored in the memory,
based on determining that the 3D model of the object is not stored, obtain an edge, a feature point, and 3D position coordinate values of pixels of the object based on the spatial image, and
segment the object from the spatial image based on the 3D segmentation and 3D vertex modeling using at least one of the obtained edge, the feature point, and the 3D position coordinate values of the pixels of the object.

8. A method, performed by an augmented reality device, for providing an augmented reality service to control an object in a real world space, the method comprising:
recognizing a first plane comprising a wall and a second plane comprising a floor from a spatial image based on a photograph of the real world space using a camera;
generating a three-dimensional (3D) model of the real world space by extending the wall and extending the floor along the respective planes and performing 3D in-painting on an area of the extended wall and the extended floor that is hidden by an obstructive object;
segmenting an object selected by a user input from the spatial image based on two-dimensional (2D) segmentation; and
segmenting the object on the spatial image from the real world space based on a 3D model or 3D position information of the object using 3D segmentation.

9. The method of claim 8, further comprising:
orienting the 3D model based on positions of the wall and the floor in the real world space; and
rendering an area in the 3D model where the object is segmented based on the 3D segmentation.

10. The method of claim 8, wherein the generating of the 3D model of the real world space comprises:
obtaining a plane equation based on the first plane and the second plane;
obtaining a 3D model shape of a virtual wall and a virtual floor, by extending the wall and the floor based on the plane equation;
identifying the object located on the wall and the floor in the real world space from the spatial image;
inpainting the area of the wall and the floor that is hidden by the object based on the spatial image; and
generating the 3D model of the real world space by applying a texture of an inpainted image to the 3D model shape of the virtual wall and the virtual floor.

11. The method of claim 10, wherein the generating of the 3D model shape of the virtual wall and the virtual floor comprises:
extracting an intersection line where the extended wall and the extended floor meet each other;
determine the first plane and the second plane based on the intersection line;
obtaining vertex coordinates based on the first plane and the second plane; and
generating the 3D model shape of the virtual wall and the virtual floor based on the vertex coordinates.

12. The method of claim 10, wherein the identifying of the object located on the wall and the floor in the real world space comprises:
identifying the object based on at least one of depth information of the real world space and color information of the real world space; and
distinguishing the wall and the floor from the object.

13. The method of claim 8, wherein the performing of the 3D segmentation comprises:
determining whether a 3D model of the object is pre-stored;
based on determining that the 3D model of the object is stored, orienting the 3D model to overlap a 2D segmentation outlier on the spatial image based on a direction of the 3D model;
obtaining a 3D position coordinate value of the object from the 3D model; and
segmenting the object from the spatial image based on the 3D position coordinate value based on 3D segmentation.

14. The method of claim 8, wherein the segmenting the object on the spatial image from the real world space based on a 3D model or 3D position information of the object using 3D segmentation comprises:
determining whether a 3D model of the object is pre-stored;
based on determining that the 3D model of the object is not stored, obtaining an edge, a feature point, and 3D position coordinate values of pixels of the object based on the spatial image; and
segmenting the object from the spatial image based on the 3D segmentation and 3D vertex modeling using at least one of the obtained edge, the feature point, and the 3D position coordinate values of the pixels of the object.

15. A non-transitory computer-readable storage medium storing one or more instructions,
wherein one or more instructions, when executed by one or more processors, cause the one or more processors to:
identify a first plane comprising a wall and a second plane comprising a floor from the spatial image;
generate a three-dimensional (3D) model of the real world space by extending the wall and extending the floor along their respective planes and performing 3D inpainting on an area of the extended wall and the extended floor that is hidden by an obstructive object;
segment an object selected by a user input from the spatial image based on two-dimensional (2D) segmentation; and
segment the object on the spatial image from the real world space based on a 3D model or 3D position information of the object using 3D segmentation.
